(19) United States
(12) Patent Application Publication
(10) Pub. No.: US 2009/0114875 A1
(43) Pub. Date: May 7, 2009

(54) PEROVSKITE OXIDE, FERROELECTRIC FILM AND FERROELECTRIC DEVICE CONTAINING THE PEROVSKITE OXIDE

(76) Inventor: Takami ARAKAWA, Kanagawa-ken (JP)

Correspondence Address: BIRCH STEWART KOLASCH & BIRCH, PO BOX 747, FALLS CHURCH, VA, 22040-0747, US

(21) Appl. No.: 12/265,643

(22) Filed: Nov. 5, 2008

(30) Foreign Application Priority Data
Nov. 6, 2007 (JP) 288529/2007

(51) Int. Cl. C04B 35/035; B32B 19/00

(52) U.S. Cl. 252/62.9 PZ; 428/220; 428/697

(57) ABSTRACT

A perovskite oxide having a composition expressed by a compositional formula,

(Pb_{1-x+δ}Aₓ)(Zr_{y}Ti_{1-y})_{1-z}M_{z}O_{w},

where Pb and A are A-site elements, Zr, Ti, and M are B-site elements, A represents one or more A-site elements other than Pb, M represents one or more of elements Nb, Ta, V, Sb, Mo, and W, x, y, and z satisfy inequalities,

0.01<x≦0.4,

0<y≦0.7, and

0.1≦z≦0.4, and

δ is approximately 0, w is approximately 3, δ and w may deviate from 0 and 3, respectively, within ranges of δ and w in which the composition expressed by the compositional formula (Pb_{1-x+δA}ₓ)(Zr_{y}Ti_{1-y})_{1-z}-M_{z}O_{w} can substantially realize a perovskite structure.

### BACKGROUND OF THE INVENTION

1. Field of the Invention

The present invention relates to a perovskite oxide, a ferroelectric film containing the perovskite oxide, and a ferroelectric device and a liquid discharge device using the ferroelectric film.

2. Description of the Related Art

Currently, the piezoelectric devices each of which are constituted by a piezoelectric body and electrodes are used, for example, as piezoelectric actuators installed in inkjet recording heads. In order to realize high-speed highly-fine printing by use of an inkjet recording head, it is necessary to increase the density at which the piezoelectric devices are arranged. Therefore, techniques for reducing the thicknesses of the piezoelectric devices are currently being studied. From the viewpoint of the precision in machining or processing, it is preferable that the piezoelectric body in a piezoelectric device used in such an inkjet recording head have a form of a thin film.

In addition, in order to realize the highly fine printing, it is necessary to use ink having high viscosity. Further, in order to enable discharge of the ink having high viscosity, the piezoelectric devices are required to exhibit high piezoelectric performance. Thus, there are demands for piezoelectric devices each being constituted by a thin piezoelectric film and having satisfactory piezoelectric performance. For example, the perovskite oxides such as lead titanate zirconate (PZT) are widely used as piezoelectric materials. The perovskite oxides are ferroelectric materials exhibiting spontaneous polarization even when no electric field is applied to the perovskite oxides.

The piezoelectric bodies of PZT and the like in the conventional piezoelectric devices are bulk bodies mounted by adhesion or films produced by screen printing. However, it is difficult to reduce the thickness of the bulk bodies below 20 micrometers. Although the thickness as small as approximately 10 micrometers can be achieved by screen printing, annealing at the temperature of 1000° C. or higher is necessary for achieving satisfactory piezoelectric performance. Although it is preferable that the substrates used in the piezoelectric devices be Si substrates since Si substrates have satisfactory workability, the Si substrates cannot be used in the piezoelectric devices manufactured by a process which includes baking at the temperature of 800° C. or higher because reaction between the Si substrates and Pb in PZT can occur when the Si substrates are heated to the temperature of 800° C. or higher.

On the other hand, it has been known, since 1960s, that the PZT doped with various donor ions having a greater valance than the valence of the ions to be substituted is superior to the intrinsic PZT in performance such as the ferroelectric performance. Various lanthanoid cations such as Bi³⁺, La³⁺, and the like are known as donor ions which substitute for Pb²⁺ at the A sites, and V⁵⁺, Nb⁵⁺, Ta⁵⁺, Sb⁵⁺, Mo⁶⁺, W⁶⁺, and the like are known as donor ions which substitute for Zr⁴⁺ and/or Ti⁴⁺ at the B sites.

In the past, the ferroelectric bodies were produced, for example, by a process in which a plurality of types of oxide powder (containing constituent elements which realize a desired composition) are mixed and the mixed powder is shaped and baked, or by a process in which an organic binder containing dispersed, mixed powder is applied to a substrate and baked. In such processes, the ferroelectric bodies are produced through a baking step at the temperature of 600° C. or higher (and normally 1000° C.), i.e., the ferroelectric bodies are produced in a thermal equilibrium state at high temperature. Therefore, in the above processes, it is impossible to dope the ferroelectric materials with a dopant having a valence which is essentially different from the valence of the atoms to be substituted with the dopant.

S. Takahashi, “Effects of Impurity Doping in Lead Zirconate-Titanate Ceramics”, Ferroelectrics, Vol. 41, pp. 143-156, 1982 reports results of studies on the doping of bulk ceramic PZT with various donor ions. FIG. 14 is a quotation from “FIG. 14” in the Takahashi reference, and shows a relationship between the amount of the dopant and the dielectric constant. FIG. 14 shows that the performance is optimized when the amount of the dopant is approximately 1.0 mol % (which corresponds to approximately 0.5 weight percent in FIG. 14), and the performance deteriorates when the amount of the dopant exceeds the optimum amount. It is possible to consider that the performance deteriorates because the donor ions which are not dissolved in solid solution due to the difference in the valence are segregated at the grain boundaries.

Japanese Unexamined Patent Publication No. 2006-096647 discloses ferroelectric films which are doped with donor ions in higher concentration than the bulk ceramic. Specifically, the ferroelectric films disclosed in JP2006-096647 are PZT-based ferroelectric films in which the A-site atoms are substituted with Bi in the concentration between 0 mol % and 100 mol %, and the B-site atoms are substituted with Nb or Ta in the concentration from 5 mol % to 40 mol %, and which are formed by the sol-gel technique. Since the sol-gel technique uses a thermal equilibrium process, it is necessary to raise the baking temperature for realizing the high-concentration doping with donor ions. According to the technique disclosed in JP2006-096647, doping with silicon or germanium as a sintering assistant is essential in order to realize the thermal equilibrium condition while promoting the sintering without raising the crystallization temperature. (See paragraph No. 0078 in JP2006-096647.) Further, heating to the temperature of approximately 650° C. to 700° C. (although it is lower than 800° C.) is required even when the sintering assistant is used. (Therefore, a Pt substrate is used in the example disclosed in JP2006-096647.) Thus, the present inventor considers that the doping with the sintering assistant is necessary when the Si substrate is used. However, when the Si substrate is used, the ferroelectric performance deteriorates, so that it is difficult to sufficiently obtain the effect of the doping with the donor ions.

In addition, since Pb in the PZT-based ferroelectric films is likely to sublime, Pb loss (defect) is likely to occur. There is a tendency for the ferroelectric performance to deteriorate when loss in the A-site atoms occurs. Therefore, it is considered more preferable that the amount of A-site loss in the PZT-based ferroelectric films be smaller. As mentioned before, JP2006-096647 discloses formation of the PZT-based ferroelectric films by the sol-gel technique. However, it is known that the sol-gel technique is likely to produce Pb loss.

### SUMMARY OF THE INVENTION

The present invention has been made in view of the above circumstances.

The first object of the present invention is to provide a PZT-based perovskite oxide which is doped with A-site substitute ions in the concentration exceeding 1 mol % and B-site substitute ions in the concentration of 10 mol % or more, is superior in ferroelectric performance such as piezoelectric performance, and can be produced without A-site defect.

The second object of the present invention is to provide a PZT-based ferroelectric film which is composed of a PZT-based ferroelectric oxide doped with A-site substitute ions in the concentration exceeding 1 mol % and B-site substitute ions in the concentration of 10 mol % or more, is superior in ferroelectric performance such as piezoelectric performance, and can be formed on a Si substrate without use of a sintering assistant.

The third object of the present invention is to provide a ferroelectric device using the PZT-based ferroelectric film which achieves the second object.

The fourth object of the present invention is to provide a liquid discharge device using the ferroelectric device which achieves the third object.

(I) In order to accomplish the above first object, a perovskite oxide according to the first aspect of the present invention is provided. The perovskite oxide according to the first aspect of the present invention has a composition expressed by a compositional formula,

(Pb_{1-x+δ}Aₓ)(Zr_{y}Ti_{1-y})_{1-z}M_{z}O_{w}. (P)

In the compositional formula (P), Pb and A are A-site elements, Zr, Ti, and M are B-site elements, A represents one or more A-site elements other than Pb, M represents one or more of elements Nb, Ta, V, Sb, Me, and W, x, y, and z satisfy inequalities,

0.01<x≦0.4,

0<y≦0.7, and

0.1≦z≦0.4.

Although normally, δ is 0, and w is 3, δ and w may deviate from 0 and 3, respectively, within ranges of δ and w in which the composition expressed by the compositional formula (P) can substantially realize a perovskite structure.

Preferably, the perovskite oxide according to the first aspect of the present invention can further have one or any possible combination of the following additional features (i) to (viii).

(i) It is preferable that x in the compositional formula (P) satisfy 0.01<x<z.

(ii) It is preferable that the one or more A-site elements represented by A have an ionic radius greater than 1.0 angstroms.

In this specification, the ionic radius is the Shannon ionic radius. (See R. D. Shannon, “Revised Effective Ionic Radii and Systematic Studies of Interatomic Distances in Halides and Chalcogenides”, Acta Crystallographica, A32, pp. 751-767, 1976.)

(iii) It is preferable that the one or more A-site elements represented by A be divalent or trivalent elements.

(iv) In the perovskite oxide having the feature (iii), it is preferable that the one or more A-site elements represented by A be one or more of metal elements Ca, Sr, Ba, Eu, Bi, Y, La, Ce, Pr, Nd, Sm, Gd, Tb, Dy, Ho, Er, Tm, Yb, and Lu.

(v) In the perovskite oxide having the feature (iv), it is more preferable that the one or more A-site elements represented by A be Bi.

(vi) It is preferable that the one or more B-site elements represented by M be Nb.

(vii) The perovskite oxide according to the first aspect of the present invention may be rich in the A-site elements. Specifically, in the compositional formula (P), 0<δ≦0.2.

(viii) The perovskite oxide according to the first aspect of the present invention may contain substantially neither of silicon and germanium. In this specification, the expression “contain substantially neither of silicon and germanium” means that the concentration of Si at the surface of a piece of the perovskite oxide (e.g., the surface of a film of the perovskite oxide), which is measured by X-ray fluorescence analysis, is lower than 0.1 wt % (weight percent), and the concentration of Ge at the surface of the piece of the perovskite oxide, which is measured by X-ray fluorescence analysis, is lower than 0.01 wt %.

(II) In order to accomplish the second object, a ferroelectric film according to the second aspect of the present invention is provided. The ferroelectric film according to the second aspect of the present invention is characterized in containing the perovskite oxide according to the first aspect of the present invention.

Preferably, the ferroelectric film according to the second aspect of the present invention can further have one or any possible combination of the following additional features (ix) to (xii).

(ix) It is possible that the ferroelectric film according to the second aspect of the present invention may have a thickness of 3.0 micrometers or greater.

(x) The ferroelectric film according to the second aspect of the present invention may be formed by a non-thermal equilibrium process, which is preferably sputtering.

(xi) The ferroelectric film according to the second aspect of the present invention may have a film structure constituted by a great number of columnar crystals.

(xii) The ferroelectric film having the feature (xi) may have a first piezoelectric constant d31(+) and a second piezoelectric constant d31(−) which satisfy the inequality,

d31(+)/d31(−)>0.5,

where the first piezoelectric constant d31(+) is measured by forming a lower electrode on a lower surface of the ferroelectric film and an upper electrode on an upper surface of the ferroelectric film, and applying a voltage to the ferroelectric film through the lower electrode and the upper electrode so that the upper electrode is at an electric potential higher than the lower electrode, the second piezoelectric constant d31(−) is measured by applying a voltage to the ferroelectric film through the lower electrode and the upper electrode so that the lower electrode is at an electric potential higher than the upper electrode, the lower surface is on a first side of the ferroelectric film from which the columnar crystals are grown, and the upper surface is on a second side of the ferroelectric film toward which the columnar crystals are grown.

(III) In order to accomplish the third object, a ferroelectric device according to the third aspect of the present invention is provided. The ferroelectric device according to the third aspect of the present invention is characterized in comprising: the ferroelectric film according to the second aspect of the present invention; and electrodes through which an electric field is to be applied to the ferroelectric film.

(IV) In order to accomplish the fourth object, a liquid discharge device according to the fourth aspect of the present invention is provided. The liquid discharge device according to the fourth aspect of the present invention is characterized in comprising: the ferroelectric device according to the third aspect of the present invention; and a discharge member being formed integrally with or separately from the ferroelectric device, where the discharge member includes a liquid-reserve chamber which reserves liquid, and a liquid-discharge outlet through which the liquid is externally discharged from the liquid-reserve chamber.

(V) The advantages of the present invention are as follows.

The perovskite oxide according to the first aspect of the present invention is a PZT-based perovskite oxide which can be produced by doping with A-site substitute ions in the concentration exceeding 1 mol % and B-site substitute ions in the concentration of 10 mol % or more without doping with a sintering assistant. Specifically, the perovskite oxide according to the first aspect of the present invention is doped with A-site donor ions in the high concentration exceeding 1 mol % up to 40 mol % and B-site donor ions in the high concentration of 10 mol % to 40 mol %. Therefore, the perovskite oxide according to the first aspect of the present invention exhibits superior ferroelectric performance (piezoelectric performance). Since the perovskite oxide according to the first aspect of the present invention can be doped with high-concentration donor ions in both of the A-sites and the B-sites without doping with a sintering assistant, it is possible to suppress the deterioration of the ferroelectric performance which is caused by the doping with the sintering assistant, and thus maximize the enhancement of the ferroelectric performance realized by the doping with the donor ions.

In the perovskite oxide according to the first aspect of the present invention, the substitute ions at the A sites can reduce the A-site loss by making up for the Pb loss (which is likely to occur, for example, during sintering of PZT). Therefore, according to the present invention, it is possible to suppress the deterioration of the ferroelectric performance.

Further, since the ferroelectric film according to the second aspect of the present invention can be formed, for example, by a non-thermal equilibrium process, the ferroelectric film according to the second aspect of the present invention can be formed below the temperature at which reaction between Si and Pb can occur. Thus, according to the present invention, it is possible to form a ferroelectric film containing a PZT-based perovskite oxide on a Si substrate without doping with a sintering assistant, where the PZT-based perovskite oxide is doped with A-site donor ions in the high concentration exceeding 1 mol % up to 40 mol % and B-site donor ions in the high concentration of 10 mol % to 40 mol %, and exhibits superior ferroelectric performance.

### DESCRIPTION OF THE DRAWINGS

FIG. 1A is a cross-sectional view schematically illustrating a cross section of a sputtering system.

FIG. 1B is a cross-sectional view schematically illustrating formation of a ferroelectric film in the sputtering system.

FIG. 2 is a diagram provided for explaining a manner of determining (measuring) a plasma potential Vs and a floating potential Vf.

FIG. 3 is a cross-sectional view schematically illustrating a cross section of a sputtering system having a shield.

FIG. 4 is a magnified cross-sectional view schematically illustrating a partial radial cross section of the sputtering system of FIG. 3 including the shield and other constituents located around the shield.

FIG. 5 is a diagram indicating a relationship between the substrate-target distance and the film-formation rate in a process for producing a ferroelectric film according to a production process.

FIG. 6 is a diagram indicating relationships between the film-formation condition and the film characteristics of PZT-based ferroelectric films produced by non-thermal equilibrium processes, where the abscissa corresponds to the film-formation temperature Ts, and the ordinate corresponds to the difference Vs−Vf.

FIG. 7 is a diagram indicating relationships between the film-formation condition and the film characteristics of PZT-based ferroelectric films produced by non-thermal equilibrium processes, where the abscissa corresponds to the film-formation temperature Ts, and the ordinate corresponds to the substrate-target distance D.

FIG. 8 is a diagram indicating relationships between the film-formation condition and the film characteristics of PZT-based ferroelectric films produced by non-thermal equilibrium processes, where the abscissa corresponds to the film-formation temperature Ts, and the ordinate corresponds to the plasma potential Vs.

FIG. 9 is a cross-sectional view schematically illustrating a cross section of an essential portion of an inkjet recording head (as a liquid discharge device) having a piezoelectric device (ferroelectric device) according to an embodiment of the present invention.

FIG. 10 is a schematic diagram of an example of an inkjet recording apparatus using the inkjet recording head of FIG. 9.

FIG. 11 is a top view of a portion of the inkjet recording apparatus of FIG. 10.

FIG. 12 is a graph indicating P-E (polarization-electric field) hysteresis curves of a Bi,Nb-PZT film as a concrete example 1 and a Nb-PZT film as a comparison example 1.

FIG. 13 is a graph indicating values of the strain measured when various values of the voltage are applied to the Bi,Nb-PZT film as the concrete example 1 and the Nb-PZT film as the comparison example 1.

FIG. 14 is a quotation from “FIG. 14” in the Takahashi reference, and shows a relationship between the amount of the dopant and the dielectric constant.

### DETAILED DESCRIPTION OF THE INVENTION

A preferred embodiment of the present invention is explained in detail below with reference to drawings.

### 1. PEROVSKITE OXIDE AND FERROELECTRIC FILM

The present inventor has found that the PZT-based ferroelectric films can be doped with A-site substitute ions in the concentration exceeding 1 mol % and B-site substitute ions in the concentration of 10 mol % or more without doping with a sintering assistant when the PZT-based ferroelectric films are formed by a non-thermal equilibrium process such as sputtering. Specifically, the present inventor has found that the PZT-based ferroelectric films can be doped with A-site donor ions in the high concentration exceeding 1 mol % up to 40 mol % and B-site donor ions in the high concentration of 10 mol % to 40 mol %.

That is, the perovskite oxide according to the present invention has a composition expressed by a compositional formula,

(Pb_{1-x+δ}Aₓ)(Zr_{y}Ti_{1-y})_{1-z}M_{z}O_{w}. (P)

In the compositional formula (P), Pb and A are A-site elements, Zr, Ti, and M are B-site elements, A represents one or more A-site elements other than Pb, M represents one or more of elements Nb, Ta, V, Sb, Mo, and W, x, y, and z satisfy the inequalities,

0.01<x≦0.4,

0<y≦0.7, and

0.1<z<0.4.

In addition, although normally, δ is 0, w is 3, δ and w may deviate from 0 and 3, respectively, within ranges of δ and w in which the composition expressed by the compositional formula (P) can substantially realize a perovskite structure. As mentioned before, according to the technique disclosed in JP2006-096647, the doping with silicon or germanium as a sintering assistant is essential. However, according to the present invention, it is possible to realize a perovskite oxide which contains substantially neither of silicon and germanium. Further, although tin (Sn) is also known as a sintering assistant, the perovskite oxide according to the present invention can also be produced so as to contain substantially no Sn.

In some conventional cases where PZT is doped with a high concentration of donor ions as substitute ions having a greater valence than the ions in each of the A-site and the B-site to be substituted with the substitute ions, the PZT is codoped with acceptor ions such as Sc or In ions instead of the sintering assistant. However, according to the present invention, it is possible to realize a perovskite oxide which contains substantially no acceptor ions.

It is known that the doping with the sintering assistant or the acceptor ions lowers the ferroelectric performance. However, since the sintering assistant or the acceptor ions are unnecessary in the perovskite oxide according to the present invention, it is possible to suppress the lowering of the ferroelectric performance, and maximize the enhancement of the ferroelectric performance realized by the doping with the donor ions. Nevertheless, the perovskite oxide according to the present invention may be doped with the sintering assistant or the acceptor ions as long as the perovskite oxide exhibits satisfactory characteristics.

Further, since the perovskite oxide according to the present invention is doped with A-site substitute ions in the concentration exceeding 1 mol % up to 40 mol %, the perovskite oxide according to the present invention contains less Pb than the intrinsic PZT or the PZT doped with only B-site substitute ions. Therefore, the perovskite oxide according to the present invention is advantageous in reduction of the environmental load.

The present inventor has found that although the bipolar P-E (polarization-versus-electric field) characteristic curve of the PZT film doped with only B-site substitute ions exhibits asymmetric hysteresis which is unbalanced toward the positive-electric-field side, the P-E characteristic curve of the ferroelectric film according to the present invention (which is doped with A-site substitute ions as well as the B-site substitute ions) is approximately a symmetric hysteresis curve exhibiting reduced asymmetry since the A-site substitute ions make up for the Pb loss. (When the absolute values of the coercive electric field Ec1 on the negative-electric-field side and the coercive electric field Ec2 on the positive-electric-field side are different (|Ec1|≠|Ec2|), the P-E hysteresis is determined to be asymmetric.)

The ferroelectric films can be used in ferroelectric devices, in which each ferroelectric film is sandwiched between an upper electrode and a lower electrode. The ferroelectric device is driven by applying an electric field to the ferroelectric film through the upper and lower electrodes. At this time, one of the upper and lower electrodes is used as a grand electrode fixed at 0 V, and the other of the upper and lower electrodes is used as an address electrode to which a driving voltage is applied. Normally, for ease of driving, the lower electrode is used as the grand electrode, and the upper electrode is used as the address electrode. In this specification, application of a positive driving voltage to the address electrode is referred to as application of a positive electric field to the ferroelectric film, and application of a negative driving voltage to the address electrode is referred to as application of a negative electric field to the ferroelectric film.

Ferroelectric films having asymmetric P-E hysteresis which is unbalanced toward the positive-electric-field side are less easily polarized when a positive electric field is applied to the terroelectric film (since the magnitude of the coercive electric field Ec1 is great), and are more easily polarized when a negative electric field is applied to the ferroelectric film (since the magnitude of the coercive electric field Ec2 is small). In order to apply the negative electric field, it is necessary to prepare a driver IC for applying a negative voltage to the upper electrode. However, since such a driver IC is not commercially available, it is necessary to newly produce a driver IC, so that the development cost increases. If the lower electrode can be patterned and used as the address electrode, and the upper electrode can be used as the grand electrode, the commercially available driver IC can be used. Nevertheless, the manufacturing process for patterning the lower electrode is complex, and is therefore undesirable.

The application of a positive electric field to a ferroelectric film to which a positive electric field cannot he originally applied is enabled by performing polarization-inversion processing on the ferroelectric film. However, it is known that the polarization-inversion processing lowers the ferroelectric performance. Therefore, it is preferable that the ferroelectric film can be driven without the polarization-inversion processing.

As explained before, the P-E characteristic curve of the ferroelectric film according to the present invention is approximately a symmetric hysteresis curve. Therefore, the ferroelectric film according to the present invention is advantageous in drivability.

The piezoelectric performance (which is a part of ferroelectric performance) of ferroelectric films can be normally evaluated by the piezoelectric constant d31. However, the ferroelectric films exhibiting a P-E characteristic curve which indicates asymmetric hysteresis unbalanced toward the positive-electric-field side are not easily polarized, so that there is a tendency for the piezoelectric constant d31(+) (i.e., the piezoelectric constant measured when a positive electric field is applied to each ferroelectric film) to be smaller than the piezoelectric constant d31(−) (i.e., the piezoelectric constant measured when a negative electric field is applied to the ferroelectric film). That is, although the piezoelectric performance is easily delivered when a negative electric field is applied to each ferroelectric film exhibiting a P-E characteristic curve which indicates asymmetric hysteresis unbalanced toward the positive-electric-field side, the piezoelectric performance is not easily delivered when a positive electric field is applied to the ferroelectric film.

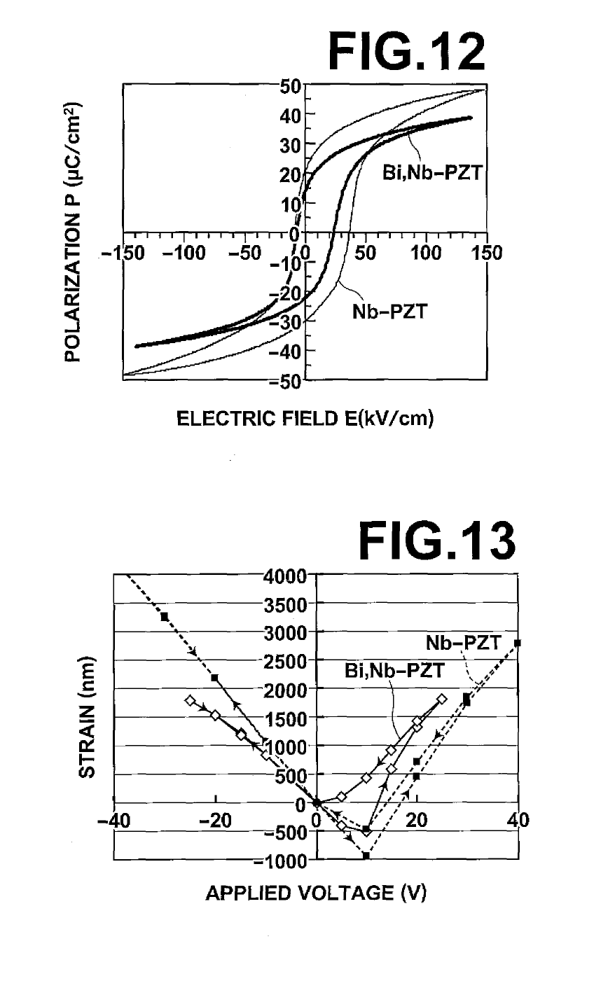

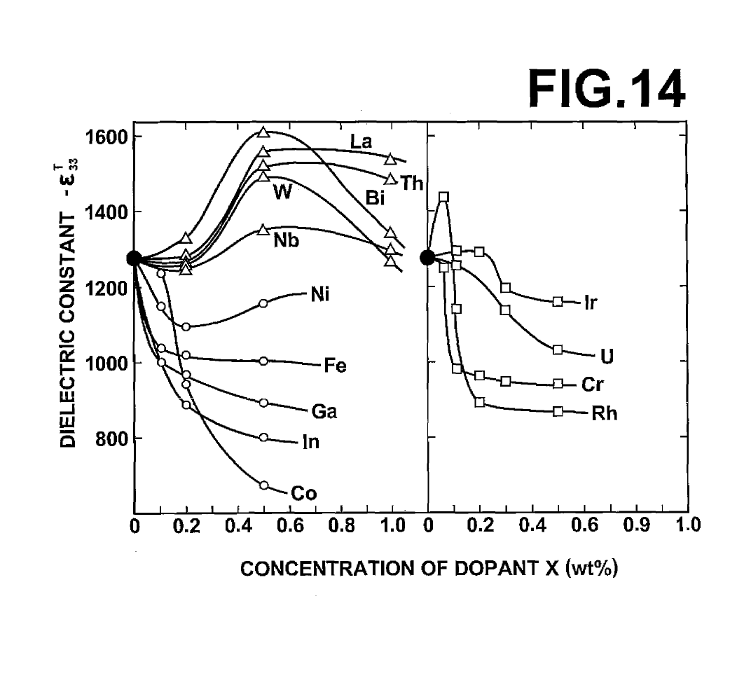

For example, as reported in Japanese Patent Application No. 2006-263978, the assignee of the present application has achieved the piezoelectric constant d31 of 250 pm/V in a PZT film doped with Nb at the B site. However, the P-E characteristic curve of the PZT films doped with only B-site substitute ions exhibits asymmetric hysteresis which is unbalanced toward the positive-electric-field side, and the above value 250 pm/V of the piezoelectric constant d31 is a value of the piezoelectric constant d31(−), which is measured when a negative electric field is applied to the ferroelectric film. The value of the piezoelectric constant d31(+) of the PZT film disclosed in Japanese patent application No. 2006-263978 is below 100 pm/V. (See FIG. 12 and Table 1.) In order to precisely discharge ink from an inkjet recording head using a piezoelectric device, it is considered preferable that the ferroelectric film in the piezoelectric device have the piezoelectric constant d31(+) above 100 pm/V. Therefore, it is preferable to correct the asymmetric hysteresis in the P-E characteristic so that the ferroelectric film has the piezoelectric constant d31(+) above 100 pm/V. In consideration of the value of the piezoelectric constant d31 of the PZT film doped with Nb at the B sites, it is possible to expect that the piezoelectric constant d31(+) exceeds 100 pm/V when d31(+)/d31(−)>0.5. Although the necessary piezoelectric characteristics of ferroelectric films are different according to the use of the ferroelectric films, in consideration of the drivability of the ferroelectric films by application of a positive electric field without the polarization-inversion processing and the driving efficiency of the ferroelectric films, it is possible to consider preferable that piezoelectric constants d31(+) and d31(−) satisfy d31(+)/d31(−)>0.5.

The ionic radii of the one or more A-site elements represented by A in the perovskite oxide according to the present invention are preferably greater than 1.0 angstroms, and more preferably greater than 1.1 angstroms.

The one or more A-site elements represented by A are preferably divalent or trivalent elements from the viewpoint of makeup for the Pb loss, and are more preferably trivalent elements since the ferroelectric performance is enhanced by the doping with the trivalent donor ions. For example, it is preferable that the one or more A-site elements represented by A be one or more of the metal elements Ca, Sr, Ba, Eu, Bi, Y, La, Ce, Pr, Nd, Sm, Gd, Tb, Dy, Ho, Er, Tm, Yb, and Lu. Further, it is possible to dope the perovskite oxide according to the present invention with one or more quadrivalent elements such as Ce and Pr.

Furthermore, the one or more A-site elements represented by A in the perovskite oxide according to the present invention may include one or more monovalent elements, for example, Na, K, Rb, Cs, and Ag. Even in the case where the one or more A-site elements represented by A include one or more monovalent elements, the one or more monovalent elements can make up for the Pb loss although the effect caused by the small valence of the monovalent elements is small.

The present inventor has found that in the case where the one or more A-site elements represented by A in the ferroelectric film according to the present invention have the ionic radii mentioned before, the one or more A-site elements can make up for the Pb loss (which is likely to be produced during sintering of PZT and the like) and reduce the Pb loss, so that the P-E characteristic curve of the ferroelectric film according to the present invention is near to a symmetric hysteresis curve, and the ferroelectric film according to the present invention has superior ferroelectric performance.

The object of JP2006-096647 is to provide ferroelectric films exhibiting a hysteresis curve with squareness which is suitable for simple-matrix type ferroelectric memories, and reports that doping with Bi at the A sites reduces oxygen loss, current leakage, imprint (deformation of the hysteresis curve), and the like, where the current leakage and the imprint impair the squareness of the hysteresis curve. (See paragraph No. 0040 in JP2006-096647).

The ferroelectric films disclosed in JP2006-096647 include PZT-based ferroelectric films doped with Bi as the A-site substitute element and Nb and/or Ta as the B-site substitute element, where the ratio between the amount of Bi as the A-site substitute element and the amount of Nb and/or Ta as the B-site substitute element is 1:1. (See the experimental examples in JP2006-096647.) JP2006-096647 reports that the PZT-based ferroelectric films are constituted by crystals of a PZT-based perovskite oxide having a single-phase perovskite structure when the Bi concentration at the A sites does not exceed 20%, and crystals of BiNbO₄ having a bismuth layered perovskite structure coexist with the crystals of the PZT-based perovskite oxide when the Bi concentration at the A sites is equal to or greater than 30%. However, the present inventor has confirmed that the piezoelectric performance of PZT-based perovskite oxides in which the ratio between the amount of Bi as the A-site substitute element and the amount of Nb and/or Ta as the B-site substitute element is 1:1 is lowered even when the Bi concentration at the A sites does not exceed 20%. (See the comparison example 1 explained later.) It is known that the piezoelectric performance of the layered perovskite compounds such as BiNbO₄ is not so high, although the layered perovskite compounds are suitable for use of residual polarization, for example, in memory devices. Therefore, it is possible to consider that the above PZT-based perovskite oxides in which the ratio between the amount of Bi as the A-site substitute element and the amount of Nb and/or Ta as the B-site substitute element is 1:1 and the Bi concentration at the A sites does not exceed 20% also contains a very small amount of crystals of BiNbO₄ having a bismuth layered perovskite structure which cannot be detected by X-ray diffraction. The present inventor considers that the technique disclosed in JP2006-096647 is based on an idea of coexistence of crystals of BiNbO₄ having a bismuth layered perovskite structure.

Further, JP2006-096647 reports that as the amounts of Bi and Nb and/or Ta increase, the squareness of the P-E hysteresis curve is incresed, i.e., the P-E hysteresis is improved. (See paragraph 0114 in JP2006-096647.) Since the object of JP2006-096647 is to provide ferroelectric films suitable for use in simple-matrix type ferroelectric memories as mentioned before, attention is focused on the squareness of the P-E hysteresis curve, and the asymmetry of the P-E hysteresis curve is not referred to in JP2006-096647 since the asymmetry of the P-E hysteresis curve is not so important for use in the simple-matrix type terroelectric memories as long as the squareness of the P-E hysteresis curve is satisfactory.

On the other hand, since the object of the present invention is to provide a perovskite oxide which exhibits satisfactory piezoelectric performance, it is preferable that the P-E characteristic curve of the perovskite oxide according to the present invention not be unbalanced toward the positive-electric-field side in order that the perovskite oxide exhibits satisfactory piezoelectric performance even when a positive electric field is applied to the perovskite oxide. In the case where the perovskite oxide is assumed to be driven by application of a positive electric field, it is not problematic for the P-E characteristic curve of the perovskite oxide according to the present invention to be unbalanced toward the negative-electric-Field side.

In order to realize satisfactory symmetry in the P-E hysteresis curve of the perovskite oxide according to the present invention without lowering the piezoelectric performance, the concentration of the one or more A-site elements represented by A is preferably lower than the concentration of the one or more B-site elements represented by M in the aforementioned compositional formula,

(Pb_{1-x+δ}Aₓ)(Zr_{y}Ti_{1-y})_{1-z}M_{z}O_{w}, and (P)

more preferably greater than 1 mol %.

In addition, although it is satisfactory that the value y indicating the composition of Ti and Zr in the compositional formula (P) satisfy 0<y≦0.7, it is preferable that the value y realize a composition in the vicinity of the morphotropic phase boundary (MPB, which is a phase transition point between the tetragonal phase and the rhombohedral phase) because the ferroelectric performance of the perovskite oxide according to the present invention further increases when in the vicinity of the MPB. That is, the value y satisfies preferably 0.45<y≦0.7, and more preferably 0.47<y<0.57.

When the value x indicating the composition of the one or more A-site elements represented by A is great, the pyrochlore phase is produced, so that the piezoelectric performance of the perovskite oxide decreases. For example, it is preferable that the value x satisfy 0.01<x<0.4. In addition, the piezoelectric performance increased by adjustment of the value x decreases when the value z indicating the composition of the one or more B-site elements represented by M is great. For example, it is preferable that the value z satisfy 0.1<z≦0.4. Further, it is preferable that the values x and z satisfy x<z.

Furthermore, from the viewpoint of the ferroelectric performance, it is preferable that the one or more B-site elements represented by M be Nb.

As mentioned before, although the sol-gel technique is used in JP2006-096647, the sol-gel technique is likely to produce Pb loss, so that the ferroelectric performance tends to be lowered. On the other hand, the present invention can provide a perovskite oxide having the composition expressed by the formula (P) with δ≧0 and containing no loss in the A-site elements, and further provide a perovskite oxide which is rich in the A-site elements (i.e., δ>0). Specifically, the present inventor has found it possible to provide a perovskite oxide which is rich in the A-site elements and having the composition expressed by the formula (P) with 0<δ. Although, the present invention can provide a perovskite oxide containing no loss in the A-site elements, the perovskite oxide according to the present invention may contain some A-site loss as long as the characteristics of the perovskite oxide is not adversely affected.

Moreover, the present invention can provide a ferroelectric film having a film structure constituted by a great number of columnar crystals, although such a film structure constituted by a great number of columnar crystals cannot be produced by the sol-gel technique as disclosed in JP2006-096647. In particular, when the ferroelectric film according to the present invention has a film structure constituted by a great number of columnar crystals which extend nonparallel to the surface of the substrate, the ferroelectric film is an oriented film in which the orientations of the crystals are aligned. The ferroelectric film having such a film structure exhibits high piezoelectric performance, and is therefore advantageous.

The piezoelectric strains of ferroelectric films include the following types (1) to (4).

(1) Normal field-induced strain (i.e., expansion and contraction along a direction in which an electric field is applied) which is produced in response to increase and decrease in the strength of the electric field when the direction of the electric field coincides with the direction of a vector component of the spontaneous polarization axis;

(2) Piezoelectric strain which is produced by reversible rotation of a polarization axis by a rotation angle different from 180 degrees when increase and decrease in the strength of the electric field causes the reversible rotation;

(3) Piezoelectric strain which is produced by a volume change caused by phase transition of a crystal when increase and decrease in the strength of the electric field causes the phase transition; and

(4) Piezoelectric strain which is produced by the engineered-domain effect when the ferroelectric film has an oriented crystal structure being formed of a material in which phase transition is caused by application of an electric field, and containing a ferroelectric phase which is oriented in a direction different from the spontaneous polarization. (The engineered-domain effect can increase the piezoelectric strain, and be utilized by applying an electric field to the ferroelectric film under a condition in which phase transition occurs, or within a range in which phase transition does not occur.)

It is possible to achieve a desired amount of piezoelectric strain by utilizing one or a combination of all or part of the above types (1) to (4) of piezoelectric strain. When a ferroelectric film has an oriented crystal structure suitable for one or more of mechanisms by which the above types of piezoelectric strain are produced, the amount of the produced piezoelectric strain becomes great. Therefore, in order to achieve high piezoelectric performance, it is preferable that the ferroelectric film have crystal orientation. For example, when the ferroelectric film is formed of a PZT-based ferroelectric material having an MPB (morphotropic phase boundary) composition, it is possible to produce a (100)-oriented columnar-crystal film.

It is sufficient that the direction of growth of the columnar crystals constituting the columnar-crystal film be nonparallel to the substrate surface, and the direction may be either perpendicular or oblique to the substrate surface.

The average diameter of the columnar crystals constituting the columnar-crystal structure is not specifically limited, and the preferable average diameter of the columnar crystals constituting the ferroelectric film is 30 nanometers to 1 micrometer. When the average diameter of the columnar crystals is too small, the crystal growth is insufficient for realizing desired ferroelectric (piezoelectric) performance. On the other hand, when the average diameter of the columnar crystals is too great, the precision in shapes after patterning deteriorates.

The present invention can provide a ferroelectric film containing the perovskite oxide according to the present invention with the composition expressed by the formula (P) and having a thickness of 3.0 micrometers or greater. On the other hand, if a thick ferroelectric film is produced by the sol-gel technique as disclosed in JP2006-096647, cracks are likely to be produced. The maximum thickness of the ferroelectric films which can be produced by the sol-gel technique as disclosed in JP2006-096647 is 1 micrometer. When the ferroelectric films are used in piezoelectric devices, the ferroelectric films having a thickness of 1 micrometer or smaller cannot achieve sufficient displacement, and it is preferable that the thicknesses of the ferroelectric films be 3.0 micrometers or greater.

As explained above, the perovskite oxide according to the present invention is a PZT-based perovskite oxide which can be produced by doping with A-site substitute ions in the concentration exceeding 1 mol % and B-site substitute ions in the concentration of 10 mol % or more without doping with a sintering assistant. Specifically, the perovskite oxide according to the present invention is a PZT-based perovskite oxide which is doped with A-site donor ions in the high concentration exceeding 1 mol % up to 40 mol % and B-site donor ions in the high concentration of 10 mol % to 40 mol %, so that the perovskite oxide according to the present invention is superior in the ferroelectric performance (piezoelectric performance). Since the perovskite oxide according to the present invention can be doped with the high concentrations of donor ions in the A- and B-sites without doping with a sintering assistant, it is possible to suppress the lowering of the ferroelectric performance caused by the doping with the sintering assistant, and maximize the enhancement of the ferroelectric performance realized by the doping with the donor ions.

In addition, the one or more A-site elements represented by A in the perovskite oxide according to the present invention improves the ferroelectric performance, and reduces the A-site loss by making up for the Pb loss, which is likely to be produced during sintering of PZT and other processes. Therefore, according to the present invention, it is possible to suppress the lowering of the ferroelectric performance caused by the A-site loss.

### 2. FIRST PRODUCTION PROCESS OF FERROELECTRIC FILM

The ferroelectric film according to the present invention containing a perovskite oxide with the composition expressed by the compositional formula (P) can be formed by a non-thermal equilibrium process. Sputtering, plasma CVD (chemical vapor deposition), sintering with rapid quenching, anneal quenching, spray quenching, and the like are examples of techniques preferable for formation of the ferroelectric film according to the present invention. In particular, sputtering is preferable for formation of the ferroelectric film according to the present invention.

As mentioned before, in the thermal equilibrium process such as the sol-gel technique, high-concentration doping with a dopant which has a valence essentially different from the valence of the material to be doped is difficult. Therefore, some contrivance such as doping with a sintering assistant or acceptor ions is necessary to achieve high-concentration doping with donor ions. On the other hand, the non-thermal equilibrium process enables high-concentration doping with donor ions without doping with a sintering assistant or acceptor ions.

Since the non-thermal equilibrium process enables film formation at relatively low temperature, which is lower than the temperature range in which reaction with Si and Pb occurs, it is possible to form the ferroelectric film on a Si substrate, which can be easily processed. Consequently, use of the non-thermal equilibrium process is desirable.

The factors of sputtering which can affect the characteristics of a ferroelectric film to be formed are considered to include the film-formation temperature, the type of the substrate, the composition of a layer (if any) which is formed on the substrate before the ferroelectric film and underlies the terroelectric film, the surface energy of the substrate, the film-formation pressure, the oxygen fraction in the atmosphere, the input power, the substrate-target distance, the electron temperature and the electron density in plasma, the density and the lifetime of active species in plasma, and the like.

Some colleagues of the present inventor have investigated ones (among a number of factors in the film formation) which greatly affect the characteristics of the ferroelectric film formed by sputtering, and found a film-formation condition which enables formation of a satisfactory film, as disclosed in Japanese patent application Nos. 2006-263978, 2006-263979, and 2006-263980.

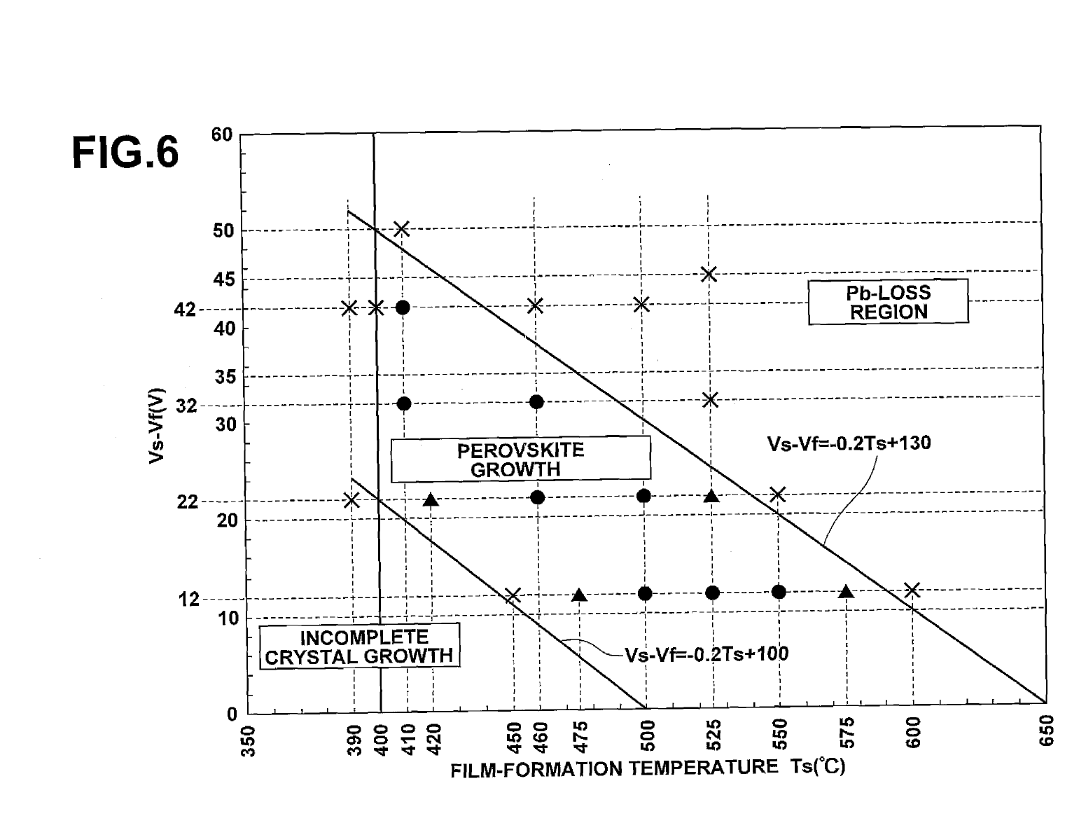

Specifically, it has been found that satisfactory films can be formed by preferably setting the film-formation temperature Ts and one of the plasma potential Vs in plasma during film formation, the substrate-target distance D, and the difference Vs−Vf between the plasma potential Vs and the floating potential Vf. The characteristic of the film with respect to the film-formation temperature Ts and each of the plasma potential Vs, the substrate-target distance D, and the difference Vs−Vf has been plotted as indicated in FIGS. 6 to 8, and it has been found that a satisfactory film can be formed in certain ranges of the film-formation temperature Ts and each of the plasma potential Vs, the substrate-target distance D, and the difference Vs−Vf. In FIGS. 6 to 8, each of the filled circles indicates that perovskite crystals having satisfactory crystal orientation are stably formed under the condition indicated by the coordinate of the filled circle in the corresponding diagram; each of the filled triangles indicates that the film characteristics vary among samples formed under the identical condition indicated by the coordinate of the filled triangle in the corresponding diagram, and disorder of the orientation begins at the condition indicated by the coordinate in the corresponding diagram; and each of the crosses indicates that the films formed under the condition indicated by the coordinate of the cross in the corresponding diagram are mainly composed of the pyrochlore phase.

In the first production process, ferroelectric films are formed by preferably setting the film-formation temperature Ts and the difference Vs−Vf between the plasma potential Vs and the floating potential Vf in plasma during film formation (in accordance with the procedure disclosed in Japanese patent application No. 2006-263978) as explained below.

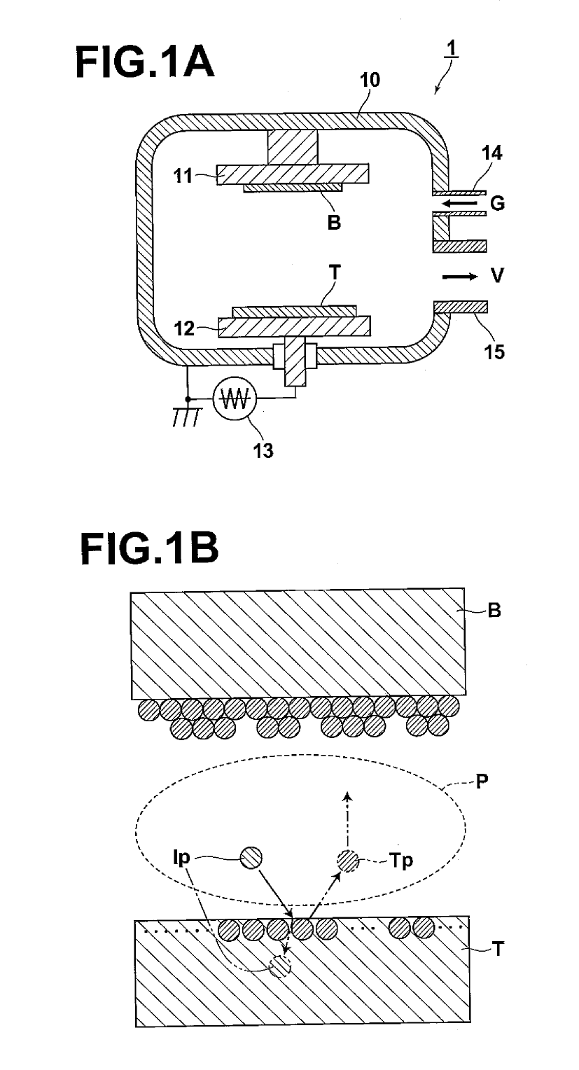

First, an example of a sputtering system is explained with reference to FIG. 1A, which is a cross-sectional view schematically illustrating a cross section of a sputtering system. Although the example of the sputtering system explained below is an RF (radio frequency) sputtering system using an RF power supply, alternatively, a DC sputtering system using a DC power supply may be used.

As illustrated in FIG. 1A, the sputtering system 1 comprises a vacuum chamber 10. In the vacuum chamber 10, a substrate holder 11 and a plasma electrode (cathode) 12 are arranged. The substrate holder 11 can hold a film-formation substrate B (on which a film is to be formed), and enables heating of the film-formation substrate B to a predetermined temperature. For example, the substrate holder 11 may be realized by an electrostatic chuck. The plasma electrode 12 generates plasma.

The substrate holder 11 and the plasma electrode 12 are arranged apart so as to face each other. The plasma electrode 12 is arranged so that a target T can be mounted on the plasma electrode 12. An RF power supply 13 is connected to the plasma electrode 12. In addition, a gas introduction tube 14 and a gas outlet tube 15 are connected to the vacuum chamber 10. The gas introduction tube 14 is provided for introducing gas G into the vacuum chamber 10, where the gas G is used for formation of the ferroelectric film. The gas exhaust tube 15 is provided for exhausting gas V from the vacuum chamber 10. The gas G introduced into the vacuum chamber 10 is Ar, a gas mixture of Ar and O₂, or the like.

FIG. 1B is a cross-sectional view schematically illustrating formation of a ferroelectric film in the sputtering system 1. As illustrated in FIG. 1B, discharge from the plasma electrode 12 turns the gas G into plasma so that positive ions Ip such as Ar ions are produced. The positive ions Ip bombard the target T, so that the atoms Tp constituting the target T are sputtered from the target T and deposited on the substrate B. At this time, the sputtered atoms Tp may be neutral or ionized. When the deposition of the sputtered atoms Tp on the substrate B is continued for a predetermined time, a film with a predetermined thickness is formed. In FIG. 1B, the plasma space is denoted by the reference P.

In the case where the ferroelectric film according to the present invention is formed by sputtering, it is preferable that the ferroelectric film be formed under a condition concurrently satisfying the inequalities (1) and (2), and it is more preferable that the ferroelectric film be formed under a condition concurrently satisfying the inequalities (1), (2), and (3).

Ts≧400 (1)

−0.2Ts+100<Vs−Vf<−0.2Ts+130 (2)

10≦Vs−Vf<35 (3)

In the inequalities (1), (2), and (3), Ts represents the film-formation temperature in degrees centigrade, Vs represents in volts the plasma potential in plasma generated during formation of the ferroelectric film, and Vf represents in volts the floating potential in the plasma generated during the formation of the ferroelectric film.

The potential of the plasma space P is the plasma potential Vs. Normally, the substrate B is made of an insulating material, and is electrically insulated from the ground (earth). Therefore, the substrate B is in a floating state, and the potential of the substrate B is the floating potential Vf. It is considered that the atoms Tp which have been sputtered from the target T and moved from the target T to the substrate B gain kinetic energy corresponding to the difference Vs−Vf in the potential between the plasma space P and the substrate B before the sputtered atoms Tp impinge the substrate B on which the film is being formed.

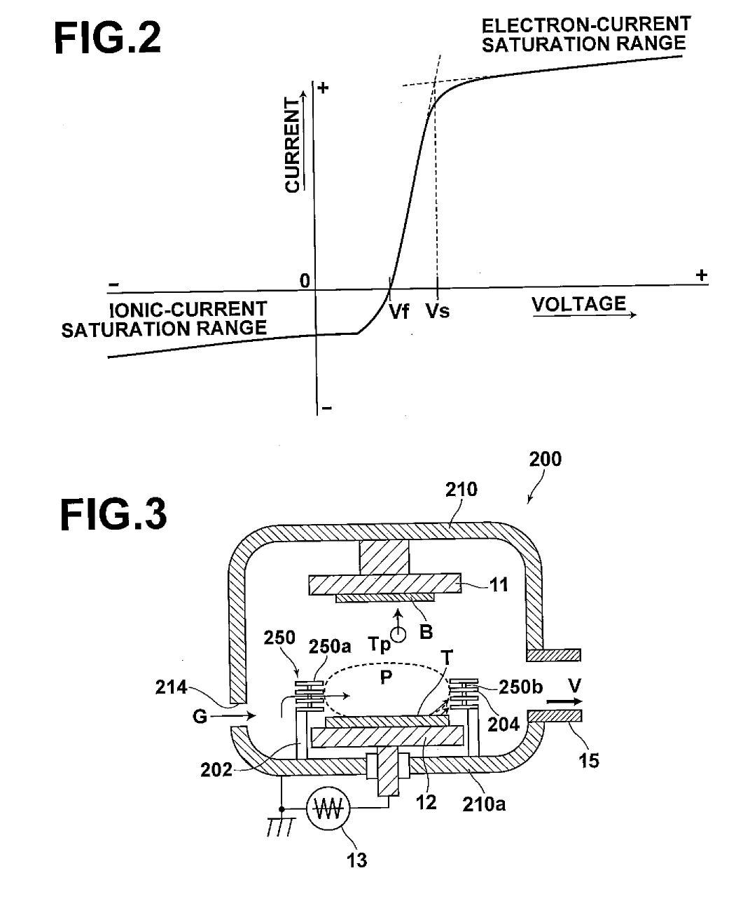

The plasma potential Vs and the floating potential Vf can be measured by using the Langmuir probe. The tip of the Langmuir probe is inserted into the plasma space P, and the voltage applied to the probe is varied. At this time, a voltage-current characteristic as indicated in FIG. 2 is obtained. (See, for example, M. Konuma, “Basics of Plasma and Film Formation”, in Japanese, Nikkan Kogyo Shinbunsha, Tokyo, p. 90, 1986.) In FIG. 2, the probe potential corresponding to the zero current is the floating potential Vf. At this point, the ion current and the electron current which flow into the probe surface are balanced. The floating potential Vf corresponds to the potential of the surface of the substrate and the surface of isolated metal. When the probe potential is raised above the floating potential Vf, the ion current gradually decreases. Then, when the probe potential becomes the plasma potential Vs, only the electron current reaches the probe.

The difference Vs−Vf between the floating potential Vf and the plasma potential Vs can be changed, for example, by arranging a ground (earth) between the substrate and the target. As mentioned before, the difference Vs−Vf corresponds to the kinetic energy of the atoms Tp which impinge the substrate B after being sputtered from the target T. Generally, the kinetic energy E can be expressed as a function of the temperature T as indicated by the equations,

E=mv²/2=3kT/2,

where m is the mass, v is the velocity, k is the Boltzmann constant, and T is the absolute temperature. Therefore, the difference Vs−Vf can be considered to have an effect similar to the temperature. In addition, the difference Vs−Vf can also be considered to have the effect of promoting surface migration, the effect of etching weakly coupled regions, and the like.

The colleagues of the present inventor have found that when the PZT-based ferroelectric film is formed under a condition that Ts<400 (i.e., the aforementioned inequality (1) is not satisfied), the perovskite crystal cannot sufficiently grow due to the low film-formation temperature, and a film mainly composed of the pyrochlore phase is formed, as indicated in FIG. 6.

The colleagues of the present inventor have found that when a PZT-based ferroelectric film is formed under a condition satisfying the inequality (1) (i.e., under the condition that the film-formation temperature satisfies the inequality Ts≧400° C.), perovskite crystals containing the pyrochlore phase at most in very small portions can stably grow under the additional condition satisfying the aforementioned inequalities (2) (i.e., under the additional condition that the difference Vs−Vf satisfies the inequalities −0.2Ts+100<Vs−Vf<−0.2Ts+130). The colleagues of the present inventor have confirmed that when the inequalities (1) and (2) are concurrently satisfied, it is possible to stably suppress the Pb loss, and stably grow a high-quality ferroelectric film having satisfactory crystal structure and composition, as indicated in FIG. 6.

It is known that the Pb loss is likely to occur when PZT-based ferroelectric films are formed by sputtering at high temperature. The colleagues of the present inventor have found that occurrence of the Pb loss depends on the difference Vs−Vf as well as the film-formation temperature Ts. Lead (Pb) exhibits the highest sputtering yield (i.e., Pb is most readily sputtered) among the constituent elements Pb, Zr, and Ti of PZT. For example, the table 8.1.7 in “Vacuum Handbook,” edited by ULVAC Inc. and published by Ohmsha in Japanese in 2002 indicates that the sputtering yields of Pb, Zr, and Ti are respectively 0.75, 0.48, and 0.65 when the Ar ion energy is 300 eV. When atoms constituting the target are ready to be sputtered, the atoms are also ready to be resputtered after the sputtered atoms are deposited on the surface of the substrate. It is possible to consider that when the difference Vs−Vf between the plasma potential Vs and the floating potential Vf (i.e., the potential of the substrate) increases, the possibility of resputtering increases and the Pb loss becomes more likely to occur.

There is a tendency that perovskite crystals cannot satisfactorily grow when PZT-based ferroelectric films are formed under a condition in which the film-formation temperature Ts is too low and the difference Vs−Vf is too small, and the Pb loss is likely to occur when PZT-based ferroelectric films are formed under a condition in which the film-formation temperature Ts is too high or the difference Vs−Vf is too great.

Therefore, in the case where PZT-based ferroelectric films are formed under a condition satisfying the aforementioned inequality (1) (Ts≧400° C.), the difference Vs−Vf is required to be relatively great for satisfactory growth of perovskite crystals when the film-formation temperature Ts is relatively low, and is required to be relatively small for suppression of the Pb loss when the film-formation temperature Ts is relatively high. The aforementioned inequalities (2) specify the above requirement.

The colleagues of the present inventor have confirmed that ferroelectric films exhibiting a high piezoelectric constant can be obtained when the ferroelectric films are formed under a condition concurrently satisfying the aforementioned inequalities (1), (2), and (3).

The colleagues of the present inventor have found that when ferroelectric films are grown under an exemplary condition that the film-formation temperature Ts is approximately 420° C. and the difference Vs−Vf is approximately 42 V, perovskite crystals can grow without the Pb loss. However, the values of the piezoelectric constant d31 of the ferroelectric films formed under the above condition are as low as approximately 100 pm/V. It is considered that since the difference Vs−Vf is too high, the kinetic energy of the atoms Tp which impinge the substrate after being sputtered from the target T is too high, and defects are likely to occur in the ferroelectric films, so that the piezoelectric constant is lowered. The colleagues of the present inventor have confirmed that when ferroelectric films are formed under a condition concurrently satisfying the aforementioned inequalities (1), (2), and (3), the values of the piezoelectric constant d31 of the ferroelectric films are equal to or greater than 130 pm/V.

### 3. PREFERABLE SPUTTERING SYSTEM

Although the sputtering system is not specifically limited as far as the potential of the plasma space can be adjusted to satisfy the aforementioned conditions according to the present invention, it is possible to adjust the potential of the plasma space in a simple manner when the sputtering system disclosed in Japanese patent application No. 2006-263981 is used. In this sputtering system, a shield is arranged around the space located on the substrate side of the target held by the substrate holder so that the existence of the shield enables adjustment of the potential of the plasma space.

Hereinbelow, an example of the sputtering system as disclosed in Japanese patent application No. 2006-263981 and a manner of film formation in the sputtering system are explained with reference to FIGS. 3 and 1B. The sputtering system explained below is an RF (radio-frequency) sputtering system using an RF power supply (high-frequency power supply), although alternatively, it is possible to use a DC sputtering system using a DC power supply. FIG. 3 is a cross-sectional view schematically illustrating a cross section of a sputtering system having the shield.

As illustrated in FIG. 3, the sputtering system 200 comprises a vacuum chamber 210. In the vacuum chamber 210, a substrate holder 11 and a plasma electrode (cathode) 12 are arranged. The substrate holder 11 can hold a substrate B (on which a film is to be formed), and enables heating of the substrate B to a predetermined level of temperature. For example, the substrate holder 11 may be realized by an electrostatic chuck. The plasma electrode 12 generates plasma.

The substrate holder 11 and the plasma electrode 12 are arranged apart so as to face each other. The plasma electrode 12 is arranged so that a target T can be mounted on the plasma electrode 12. The target T has the composition corresponding to the composition of the film to be formed. The plasma electrode 12 is connected to an RF power supply 13. The plasma electrode 12 and the RF power supply 13 constitute a plasma generation unit. A shield 250 is arranged around a space located on the substrate side of the target T or on the substrate side of the plasma electrode 12 (as the target holder).

In addition, a gas introduction tube 214 and a gas outlet tube 215 are connected to the vacuum chamber 210. The gas introduction tube 214 is provided for introducing gas G into the vacuum chamber 210, where the gas (film-formation gas) G is used for formation of the ferroelectric film. The gas exhaust tube 215 is provided for exhausting gas (exhaust gas) V from the vacuum chamber 210. The gas introduction tube 214 is arranged opposite to the gas outlet tube 215 at an approximately identical elevation to the gas exhaust tube 215.

The gas G introduced into the vacuum chamber 210 is Ar, a gas mixture of Ar and O₂, or the like. As illustrated in FIG. 1B, discharge caused by the plasma electrode 12 turns the gas G into plasma so that positive ions Ip such as Ar ions are produced. The positive ions Ip bombard the target T, so that the atoms Tp constituting the target T are sputtered from the target T and deposited on the substrate B. At this time, the sputtered atoms Tp may be either neutral or ionized.

Further, the sputtering system 200 is characterized in that the shield 250 is arranged around the space located on the substrate side of the target T in the vacuum chamber 210. Specifically, the shield 250 is arranged on an earth shield 202 as a grounding member. The earth shield 202 is arranged on the bottom surface 210a of the vacuum chamber 210 so as to stand around the plasma electrode 12. The earth shield 202 is provided for preventing lateral or downward discharge from the plasma electrode 12 to the vacuum chamber 210.

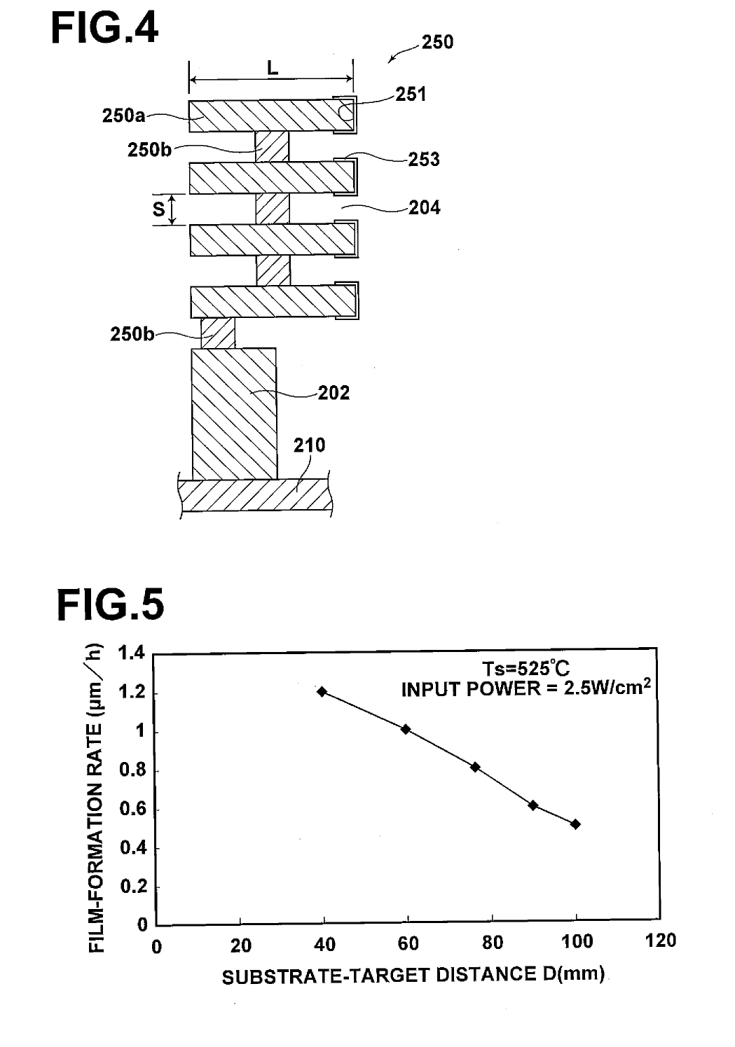

For example, the shield 250 is constituted by a plurality of annular metal plates (rings or fins) 250a as illustrated in FIG. 4, which is a magnified cross-sectional view schematically illustrating a partial radial cross section of the sputtering system of FIG. 3 including the shield and other constituents located around the shield. In the example of FIG. 4, the number of the annular metal plates 250a is four. The annular metal plates 250a are spaced in the vertical direction, so that gaps 204 exist between the annular metal plates 250a and the gas G can easily flow through the gaps 204. A plurality of conductive spacers 250b are arranged in each gap between the annular metal plates 250a in such a manner that the plurality of conductive spacers 250b are spaced in the circumferential direction. In addition, in order to provide further paths of the gas G between the lowermost one of the annular metal plates 250a and the top surface of the earth shield 202, it is preferable that a plurality of conductive spacers 250b also be arranged between the lowermost one of the annular metal plates 250a and the top surface of the earth shield 202 in a similar manner.

The shield 250 is grounded through the electrical connection with the earth shield 202 and the vacuum chamber 210. Although the materials of which the annular metal plates 250a and the conductive spacers 250b are made are not specifically limited, the annular metal plates 250a and the conductive spacers 250b are preferably made of stainless steel (SUS).

Further, although not shown, the annular metal plates 250a may be electrically connected with additional conductive members which connect the annular metal plates 250a at the outer edges of the annular metal plates 250a. The provision of the additional conductive members enhances the effect of grounding of the annular metal plates 250a.

Since the shield 250 is arranged around the space located on the substrate side of the target T in the vacuum chamber 210, and grounded, the ground potential is realized around the space located on the substrate side of the target T.

In the sputtering system 200, it is possible to preferably adjust and set the condition of the plasma by using the shield 250. Specifically, the difference Vs−Vf between the plasma potential Vs and the floating potential Vf can be preferably adjusted as explained below.

When an RF voltage generated by the RF power supply 13 is applied to the plasma electrode 12 for forming a film on the substrate B, plasma is generated above the target T. At this time, discharge also occurs between the target T and the shield 250. It is considered that this discharge enables confinement of the plasma in the space surrounded by the shield 250, so that the plasma potential Vs is lowered and the difference Vs−Vf decreases. The decrease in the difference Vs−Vf results in decrease in the kinetic energy of the atoms Tp which impinge the substrate B after being sputtered from the target T. That is, it is possible to preferably control the kinetic energy of the atoms Tp impinging the substrate B after being sputtered from the target T, by preferably adjusting the difference Vs−Vf so as to form a satisfactory film.

There is a tendency that the difference Vs−Vf decreases with increase in the number of the annular metal plates 250a and the height of the shield. The colleagues of the present inventor consider that the reason for the tendency is that when the height of the shield increases, the discharge between the target T and the shield 250 increases and the difference Vs−Vf decreases.

It is possible to determine an optimum value of the difference Vs−Vf for a specific value of the film-formation temperature. In addition, it is also possible to realize the optimum potential difference by adjusting the number of the annular metal plates 250a without changing the film-formation temperature. Since the annular metal plates 250a are simply stacked through the conductive spacers 250b, it is possible to change the number of the annular metal plates 250a by removing or additionally stacking an annular metal plate.

The lowermost one of the annular metal plates 250a is apart from the outer edge of the target T. If the distance (along a straight line) from the outer edge of the target T to the lowermost one of the annular metal plates 250a is zero, discharge occurs. On the other hand, if the lowermost one of the annular metal plates 250a is too far from the outer edge of the target T, the shielding effect is reduced. The distance (along a straight line) from the outer edge of the target T to the lowermost one of the annular metal plates 250a is preferably 1 to 30 mm.

The atoms Tp sputtered from the target T can also be deposited on the annular metal plates 250a as well as the target T, since the annular metal plates 250a are located around the target T. The atoms Tp are mostly deposited on the inner edges of and the vicinities of the inner edges of the annular metal plates 250a. Specifically, as illustrated in FIG. 4, particles of the atoms Tp are deposited and films 253 are formed on the inner edge surfaces and the portions, near the inner edges, of the upper and lower surfaces of the annular metal plates 250a. If the atoms Tp sputtered from the target T are deposited and films are formed on the entire surfaces of the annular metal plates 250a, the function of the annular metal plates 250a as the ground (earth) is lost. Therefore, it is preferable that the shield 250 be arranged to be as resistant as possible to deposition of the particles of the atoms Tp.

Since the shield 250 in the sputtering system 200 is constituted by the plurality of annular metal plates 250a spaced in the vertical direction with the gaps 204, it is possible to prevent deposition of the atoms Tp sputtered from the target T on the entire surfaces of the shield 250 and change in the potential of the shield 250. Therefore, even when film formation is repeated, the function of the shield 250 is stable and effective, so that the difference Vs−Vf is stably maintained.

In particular, it is desirable that the width L of the annular metal plates 250a in the radial direction and the amount S of the gap 204 between the annular metal plates 250a satisfy the inequality L>S, i.e., the width of the annular metal plates 250a is at least equal to the amount S of the gap 204. In this case, the sputtered atoms Tp are less likely to deposit on the entire surfaces of the annular metal plates 250a. That is, since the depths from the inner edges of the annular metal plates 250a are increased, the sputtered atoms Tp are less likely to move through the gaps 204 to the vicinities of the outer edges of the annular metal plates 250a, so that it is possible to prevent loss of the function of the shield 250 in a short time.

Further, it is possible to expect another effect of the gaps 204. Since the gaps 204 serve as paths of the film-formation gas G, the film-formation gas G can easily reach the portion of the plasma space in the vicinities of the target T through the gaps 204, and the gas ions produced by the plasma generation in the vicinity of the target T can easily reach the target T, so that the atoms Tp constituting the target T can be effectively sputtered. Thus, it is possible to consider that a satisfactory film having desirable characteristics can be stably formed.

Even in the case where the shield 250 has the gaps 204, the annular metal plates 250a can form an equipotential wall on the inner edge side as a gapless shield forms, the effect of the shield 250 (with the gaps 204) in controlling the difference Vs−Vf is equivalent to the effect of the gapless shield.

The difference Vs−Vf in the sputtering system 200 can be controlled by adjusting the height of the shield 250. The difference Vs−Vf can also be controlled by changing the input power supplied to the target T, the film-formation pressure, and the like. However, in the case where the difference Vs−Vf is controlled by changing the input power supplied to the target T, the film-formation pressure, and the like, sometimes, other parameters such as the film-formation rate also vary, so that desirable quality of the film cannot be achieved. The colleagues of the present inventor have performed an experiment of film formation under a certain condition, and found that when the input power supplied to the target T is decreased from 700 W to 300 W, the film-formation rate decreases from 4 μm/h to 2 μm/h although the difference Vs−Vf can be decreased from 38 V to 25 V. In the case where the sputtering system 200 is used, the difference Vs−Vf can be adjusted without changing other parameters such as the film-formation rate, so that it is easy to preferably set the film-formation condition, and a satisfactory film can be stably formed.

As explained above, since the ferroelectric film according to the present invention containing a perovskite oxide can be formed by a non-thermal equilibrium process, the ferroelectric film can be formed at relatively low temperature, which is lower than the temperature range in which reaction with Si and Pb occurs. Therefore, according to the present invention, it is possible to form a ferroelectric film which is doped with A-site substitution ions in a concentration higher than 1 mol % and B-site substitution ions in a concentration of 10 mol % or higher and exhibits superior ferroelectric performance, on a Si substrate without using a sintering assistant.

### 4. SECOND PRODUCTION PROCESS OF FERROELECTRIC FILM

In the second production process, ferroelectric films are formed by using the sputtering system similar to the system illustrated in FIGS. 1A and 1B, and preferably setting the film-formation temperature Ts and the substrate-target distance D (i.e., the distance D between the substrate B and the target T) (in accordance with the procedure disclosed in Japanese patent application No. 2006-263979) as explained below.

In the second production process, it is preferable that the ferroelectric film be formed under a condition concurrently satisfying the inequalities,

400≦Ts≦500, and (4)

30≦D≦80, (5)

where Ts represents the film-formation temperature in degrees centigrade, and D represents in millimeters a distance between the substrate and the at least one target.

In the second production process, it is also preferable that the ferroelectric film be formed under a condition that the inequalities,

500≦Ts≦600, and (6)

30≦D≦100, (7)

are concurrently satisfied.

A colleague of the present inventor has found that when the PZT-based ferroelectric film is formed under a condition that Ts<400 (i.e., under a condition that the inequalities (4) is not satisfied), the perovskite crystal cannot sufficiently grow due to the low film-formation temperature, and a film mainly composed of the pyrochlore phase is formed.

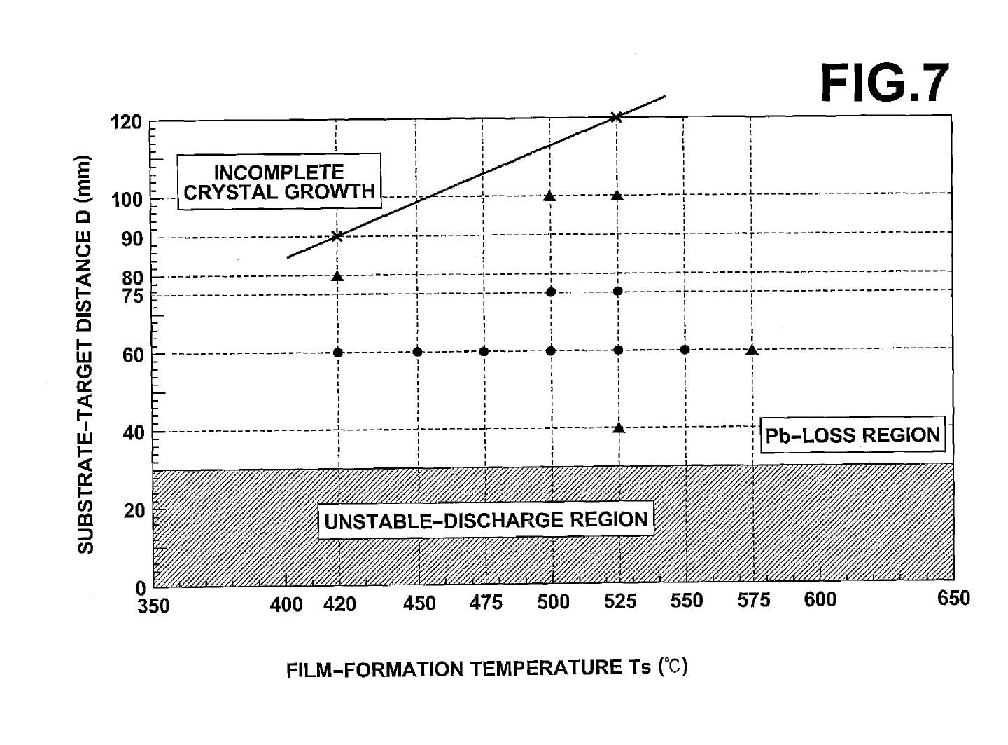

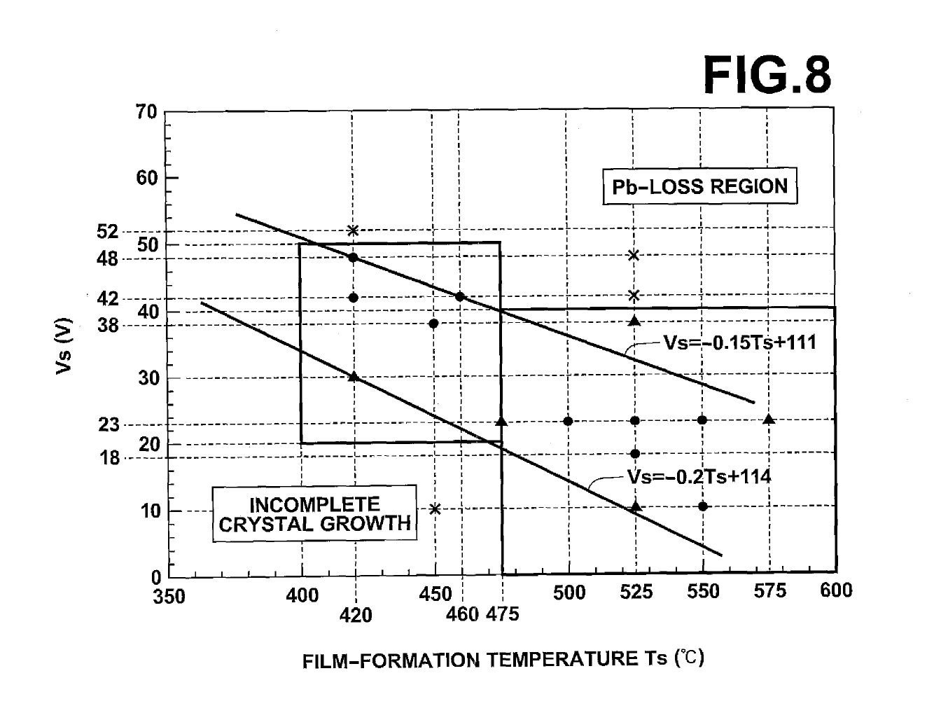

The colleague of the present inventor has also found that when the PZT-based ferroelectric film is formed under a condition that 400° C.≦Ts≦500° C. (i.e., under a condition that the inequalities (4) are satisfied), perovskite crystals containing the pyrochlore phase at most in very small portions can stably grow under an additional condition that 30≦D (mm)≦80 (i.e., under a condition that the inequalities (5) are satisfied). The colleague of the present inventor has further found that when the PZT-based ferroelectric film is formed under a condition that 500° C.≦Ts≦600° C. (i.e., under a condition that the inequalities (6) are satisfied), perovskite crystals containing the pyrochlore phase at most in very small portions can stably grow under an additional condition that 30≦D (mm)≦100 (i.e., under a condition that the inequalities (7) are satisfied). The colleague of the present inventor has confirmed that when the inequalities (4) and (5), or the inequalities (6) and (7) are concurrently satisfied, it is possible to stably suppress the Pb loss, and stably grow a high-quality piezoelectric film having satisfactory crystal structure and composition. (See FIG. 7.)

In the second production process, there is a tendency that perovskite crystals cannot satisfactorily grow when the film-formation temperature is too low and the substrate-target distance D is too great. In addition, there is another tendency that lead is likely to be lost when the film-formation temperature is too low and the substrate-target distance D is too small. Therefore, in the case where PZT-based ferroelectric films are formed under a condition satisfying the aforementioned inequalities (4) (400° C.≦Ts≦500° C.), the substrate-target distance D is required to be relatively small for satisfactorily growing perovskite crystals when the film-formation temperature Ts is relatively low, and is required to be relatively great for suppressing occurrence of the Pb loss when the film-formation temperature Ts is relatively high. The aforementioned inequalities (5) specify the above requirement. Similarly, the aforementioned inequalities (7) specify the above requirement for the case where PZT-based ferroelectric films are formed under a condition satisfying the aforementioned inequalities (6) (500° C.≦Ts≦600° C.), although the upper limit of the range of the substrate-target distance D specified by the inequalities (7) is greater than the upper limit specified by the inequalities (5) since the film-formation temperatures Ts specified by the inequalities (6) are higher than the film-formation temperatures Ts specified by the inequalities (4).

From the viewpoint of the manufacturing efficiency, a higher film-formation rate is more preferable. Specifically, the film-formation rate is preferably 0.5 μm/h, and more preferably 1.0 μm/h. As illustrated in FIG. 5, the film-formation rate increases with decrease in the substrate-target distance D. FIG. 5 is a diagram indicating a relationship between the substrate-target distance D and the film-formation rate in the process for producing a PZT film according to the second production process. In FIG. 5, the film-formation temperature Ts is 525, and the input power (RF power) supplied to the target T is 2.5 W/cm². According to the present invention, it is possible to form a film having satisfactory quality even under a high-speed film-formation condition that the film-formation rate is 1.0 μm/h or higher. The film-formation rate can become lower than 0.5 μm/h according to the substrate-target distance D. In such a case, it is desirable to adjust the input power supplied to the target T, and the like so as to increase the film-formation rate to 0.5 μm/h or higher.

It is preferable that the substrate-target distance D be smaller from the viewpoint of the film-formation rate. Preferably, the substrate-target distance D is 80 mm or smaller in the case where the film-formation temperature Ts is in the range of 400° C. to 500° C., and 100 nm or smaller in the case where the film-formation temperature Ts is in the range of 500° C. to 600° C. When the substrate-target distance D is smaller than 30 mm, the plasmic state becomes unstable, so that films having satisfactory quality may not be formed. In order to stably form piezoelectric films having higher quality, it is preferable that the substrate-target distance D be in the range of 50 to 70 mm in either of the range of 400° C. to 500° C. and the range of 500° C. to 600° C.

The colleague of the present inventor has confirmed that when the film-formation condition satisfies the inequalities (4) and (5) or the inequalities (6) and (7), it is possible to stably form high-quality piezoelectric films having satisfactory quality at high manufacturing efficiency (i.e., at high film-formation rate).

As explained above, the second production process also uses a non-thermal equilibrium process (by which the ferroelectric films containing a perovskite oxide can be formed), and therefore has similar advantages to the first production process.

### 5. THIRD PRODUCTION PROCESS OF FERROELECTRIC FILM

In the third production process, ferroelectric films are formed by using the sputtering system similar to the system illustrated in FIGS. 1A and 1B, and preferably setting the film-formation temperature Ts and the plasma potential Vs in plasma during film formation (in accordance with the procedure disclosed in Japanese patent application No. 2006-263980) as explained below.

In the third production process, it is preferable that the ferroelectric film be formed under a condition concurrently satisfying the inequalities,

400≦Ts≦475, and (8)

20 Vs 50, (9)

where Ts represents the film-formation temperature in degrees centigrade, and Vs represents in volts a plasma potential in plasma generated during formation of the ferroelectric film.

In the third production process, it is also preferable that the ferroelectric film be formed under a condition that the inequalities,

475≦Ts≦600, and (10)

Vs≦40, (11)

are concurrently satisfied.

The plasma potential Vs can be changed, for example, by arranging a ground (earth) between the substrate B and the target T. Similar to the difference Vs−Vf, the plasma potential Vs can also be considered to have the effect of promoting surface migration, the effect of etching weakly coupled regions, and the like.

The colleague of the present inventor has found that when piezoelectric films containing a perovskite oxide with the composition expressed by the compositional formula (P) is formed under a condition that 400° C.≦Ts≦475° C. (i.e., under a condition that the inequalities (8) are satisfied), perovskite crystals containing the pyrochlore phase at most in very small portions can stably grow under an additional condition that 20≦Vs≦50 (i.e., under a condition that the inequalities (9) are satisfied). The colleague of the present inventor has further found that when piezoelectric films containing a perovskite oxide with the composition expressed by the compositional formula (P) is formed under a condition that 475° C.≦Ts≦600° C. (i.e., under a condition that the inequalities (10) are satisfied), perovskite crystals containing the pyrochlore phase at most in very small portions can stably grow under an additional condition that Vs≦40 (i.e., under a condition that the inequality (11) is satisfied). In addition, the colleague of the present inventor has also confirmed that when the inequalities (8) and (9), or the inequalities (10) and (11) are concurrently satisfied, it is possible to stably suppress the Pb loss.

Further, the colleague of the present inventor has found that in order to stably form piezoelectric films having more satisfactory crystal structure and composition, it is preferable to determine the film-formation condition so as to satisfy the inequalities,

420≦Ts≦575, and (12)

−0.15Ts+111<Vs<−0.2Ts+114. (13)

where Ts represents the film-formation temperature in degrees centigrade, and Vs represents in volts a plasma potential in plasma generated during formation of the ferroelectric film.

Furthermore, the colleague of the present inventor has found that in order to stably form piezoelectric films having more satisfactory crystal structure and composition, it is particularly preferable to determine the film-formation condition so as to satisfy the inequalities (14) and (15) or the inequalities (16) and (17) indicated below. (See FIG. 8.)

420≦Ts≦460 (14)

30≦Vs≦48 (15)

475≦Ts≦575 (16)

10≦Vs<38 (17)

In the inequalities (14), (15), (16), and (17), Ts represents the film-formation temperature in degrees centigrade, and Vs represents in volts a plasma potential in plasma generated during formation of the ferroelectric film.

In the third production process, there is a tendency that perovskite crystals cannot satisfactorily grow when both of the film-formation temperature and the plasma potential Vs are too low. In addition, there is another tendency that lead is likely to be lost when either of the film-formation temperature and the plasma potential Vs is too great.

Although the substrate-target distance D is not specifically limited in the third production process, the substrate-target distance D is preferably 30 to 80 mm. Since the film-formation rate increases with decrease in the substrate-target distance D, the decrease in the substrate-target distance D increases efficiency. However, when the substrate-target distance D is too small, the plasmic state becomes unstable, so that formation of a satisfactory film is difficult.

The colleague of the present inventor has confirmed that when a piezoelectric film of a perovskite oxide expressed by the compositional formula (P) is formed under a condition concurrently satisfying the inequalities (8) and (18), or the inequalities (10) and (19) indicated below, the dielectric constant d31 of the piezoelectric film becomes high.

400≦Ts≦475 (8)

35≦Vs≦45 (18)

475≦Ts≦600 (10)

10≦Vs≦35 (19)

The colleague of the present inventor has confirmed that when a piezoelectric film of a perovskite oxide expressed by the compositional formula (P) is formed at the film-formation temperature Ts of approximately 420° C. and the plasma potential Vs is approximately 48 V, perovskite crystals can grow without the Pb loss. However, the piezoelectric constant d31 of the piezoelectric film formed under the above conditions that Ts=420° C. and Vs=48 V has been found to be as low as approximately 100 pm/V. It is possible to consider that the kinetic energy of the atoms Tp impinging the substrate is too high under the conditions that Ts=420° C. and Vs=48 V, so that defects are likely to be produced in the films, and the dielectric constant decreases. The colleague of the present inventor has confirmed that when piezoelectric films are formed under the condition concurrently satisfying the inequalities (8) and (18), or the inequalities (10) and (19), the values of the piezoelectric constant d31 of the piezoelectric films can be 130 pm/V or higher.

As explained above, the third production process also uses a non-thermal equilibrium process (by which the ferroelectric films containing a perovskite oxide can be formed), and therefore has similar advantages to the first production process.

### 6. PIEZOELECTRIC DEVICE AND INKJET RECORDING HEAD

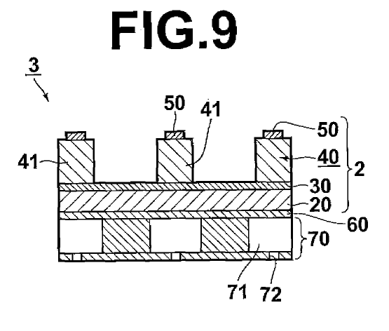

Hereinbelow, the structure of an inkjet recording head (as an embodiment of the liquid discharge device according to the fourth aspect of the present invention) containing a piezoelectric device (as an embodiment of the ferroelectric device according to the third aspect of the present invention) is explained with reference to FIG. 9, which is a cross-sectional view schematically illustrating a cross section of an essential portion of the inkjet recording head. In FIG. 9, the dimensions of the illustrated elements are differentiated from the actual dimensions of the elements of the inkjet recording head for clarification.

In outline, the inkjet recording head 3 illustrated in FIG. 9 is constituted by a piezoelectric device 2, a diaphragm 60, and an ink-nozzle member 70.

The piezoelectric device 2 is produced by forming on a substrate 20 a lower electrode 30, a ferroelectric (piezoelectric) film 40, and upper electrodes 50 in this order so that an electric field in the thickness direction can be applied to each portion (corresponding to a pixel or an ink chamber) of the ferroelectric film 40 through the lower electrode 30 and the upper electrodes 50. The ferroelectric film 40 is a ferroelectric film according to the present invention containing the perovskite oxide having the composition expressed by the compositional formula (P).

The lower electrode 30 is formed over approximately the entire (upper) surface of the substrate 20. The ferroelectric film 40 formed on the lower electrode 30 is patterned into protruding portions 41 in a stripelike arrangement, where each of the protruding portions 41 has a linear shape and extends in the direction perpendicular to the plane of FIG. 9. The upper electrodes 50 are respectively formed on the protruding portions 41. However, the pattern of the ferroelectric film 40 is not limited to the above arrangement, and other patterns may be used according to necessity. Although the ferroelectric film 40 maybe a continuous (solid) ferroelectric film, it is preferable to pattern the ferroelectric film 40 into the separate protruding portions 41 since the separate protruding portions can smoothly expand and contract, and achieve great displacement.

The material (composition) of the substrate 20 is not specifically limited. For example, the substrate 20 may be made of silicon, glass, stainless steel (SUS), YSZ (yttrium stabilized zirconia), alumina, sapphire, silicon carbide, or the like. In addition, the substrate 20 may be realized by a laminated substrate such as the SOI (silicon-on-insulator) substrate, which is produced by alternately forming on a surface of a silicon substrate one or more oxide films of SiO₂ and one or more Si active layers.

The main component of the lower electrode 30 is not specifically limited, and may be, for example, one or a combination of metals such as Au, Pt, and Ir, metal oxides such as IrO₂, RuO₂, LaNiO₃, and SrRuO₃.

The main component of the upper electrodes 50 is not specifically limited, and may be, for example, one or a combination of metals such as Au, Pt, and Ir, metal oxides such as IrO₂, RuO₂, LaNiO₃, and SrRuO₃, and the materials which are generally used for electrodes in the semiconductor processes, such as Al, Ta, Cr, and Cu.

Although the thicknesses of the lower electrode 30 and the upper electrodes 50 are not specifically limited, the thicknesses of the lower electrode 30 and the upper electrodes 50 are, for example, approximately 200 nm. Although the thickness of the ferroelectric film 40 (i.e., the height of the protruding portions 41) is not specifically limited, the thickness of the ferroelectric film 40 is normally 1 micrometer or greater, and is, for example, 1 to 5 micrometers. It is preferable that the thickness of the ferroelectric film 40 be 3 micrometers or greater.

In outline, the inkjet recording head 3 is produced by attaching the diaphragm 60 to the back surface of the substrate 20 of the piezoelectric device 2, and attaching the ink-nozzle member 70 to the diaphragm 60. The ink-nozzle member 70 comprises ink chambers 71 (as the liquid-reserve chambers) and ink-discharge outlets 72 (as the liquid-discharge outlets). Each of the ink chambers 71 is connected to the corresponding one of the ink chambers 71. Each of the ink chambers 71 reserves the ink, and the ink held in the ink chamber is discharged out of the ink chamber through the corresponding ink-discharge outlet. The ink chambers 71 are arranged in correspondence with the protruding portions 41 of the ferroelectric film 40.

Alternatively, it is possible to process portions of the substrate 20 into the diaphragm 60 and the ink-nozzle member 70, instead of separately preparing the diaphragm 60 and the ink-nozzle member 70 and attaching the diaphragm 60 and the ink-nozzle member 70 to the piezoelectric device 2. For example, in the case where the substrate 20 is formed by a laminated substrate such as the SOI substrate, the ink chambers 71 can be formed by etching the corresponding portions of the substrate 20 from the bottom surface of the substrate 20, and the diaphragm 60 and the structures of the ink-nozzle member 70 can be produced by processing the substrate 20 per se.

In the above inkjet recording head 3, the strength of the electric field applied to each portion (corresponding to a pixel or an ink chamber) of the piezoelectric device 2 is increased or decreased so as to expand or contract each portion of the piezoelectric device 2 and control the discharge of the ink from the corresponding one of the ink chambers 71 and the discharge amount of the ink.

### 7. INKJET RECORDING APPARATUS

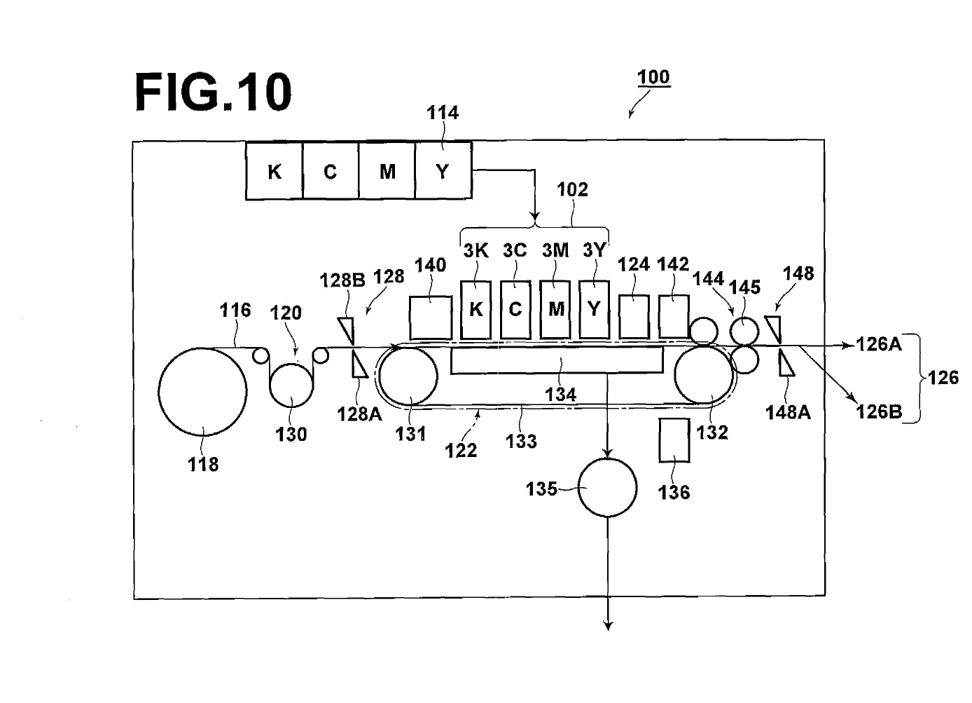

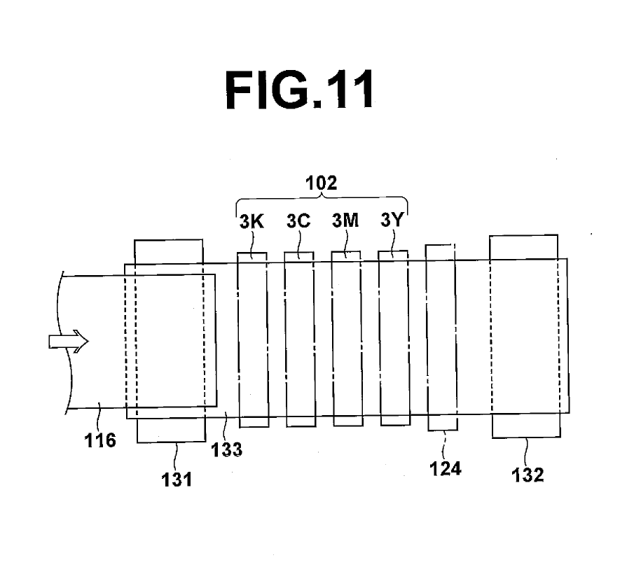

Hereinbelow, an example of an inkjet recording apparatus having the inkjet recording head 3 is explained with reference to FIGS. 10 and 11. FIG. 10 is a schematic diagram illustrating an outline of an example of an inkjet recording apparatus having the inkjet recording head 3 of FIG. 9, and FIG. 11 is a top view of a portion of the inkjet recording apparatus of FIG. 10.

As schematically illustrated in FIG. 10, the inkjet recording apparatus 100 comprises a printing unit 102, an ink reserve-and-load unit 114, a sheet feeding unit 118, a decurling unit 120, a suction-type belt conveyer 122, a print detection unit 124, and a sheet output unit 126. The printing unit 102 comprises a plurality of inkjet recording heads 3K, 3C, 3M, and 3Y corresponding to inks of different colors (specifically, black (K), cyan (C), magenta (M), and yellow (Y)). Hereinafter, the inkjet recording heads may be referred to as heads. The ink reserve-and-load unit 114 reserves the inks to be supplied to the heads 3K, 3C, 3M, and 3Y. The sheet feeding unit 118 feeds a recording sheet 116. The decurling unit 120 eliminates curl of the recording sheet 116. The suction-type belt conveyer 122 is arranged to face the nozzle faces (ink-discharge faces) of the printing unit 102, and conveys the recording sheet 116 while maintaining the flatness of the recording sheet 116. The print detection unit 124 reads an image printed on the recording sheet 116 by the printing unit 102. The sheet output unit 126 externally outputs a printed recording sheet 116.

Each of the heads 3K, 3C, 3M, and 3Y constituting the printing unit 102 corresponds to the inkjet recording head according to the present embodiment as explained before. In order to realize a linear head (explained later), each inkjet recording head used in the inkjet recording apparatus 100 comprises a plurality of ink chambers and a plurality of ink-discharge outlets.

The decurling unit 120 performs decurling of the recording sheet 116 by heating the recording sheet 116 with a heating drum 130 so as to eliminate the curl produced in the sheet feeding unit 118.

In the case where the inkjet recording apparatus 100 uses roll paper, a cutter 128 for cutting the roll paper into desired size is arranged in the stage following the decurling unit 120 as illustrated in FIG. 10. The cutter 128 is constituted by a fixed blade 128A and a round blade 128B. The fixed blade 128A has a length equal to or greater than the width of the conveying path of the recording sheet 116, and is arranged on the side opposite to the print side of the recording sheet 116. The round blade 128B is arranged opposite to the fixed blade 12SA on the print side of the recording sheet 116, and moves along the fixed blade 128A. In the inkjet recording apparatuses using cut paper, the cutter 128 is unnecessary.

After the roll paper is decuried and cut into the recording sheet 116, the recording sheet 116 is transferred to the suction-type belt conveyer 122. The suction-type belt conveyer 122 is constituted by rollers 131 and 132 and an endless belt 133. The rollers 131 and 132 are placed apart and the endless belt 133 is looped around the rollers 131 and 132 in such a manner that at least portions of the endless belt 133 which face the nozzle faces of the printing unit 102 and the sensor face of the print detection unit 124 are flat and horizontal.

The endless belt 133 has a width greater than the width of the recording sheet 116, and a great number of suction pores (not shown) are formed through the endless belt 133. A suction chamber 134 is arranged inside the loop of the endless belt 133 at the position opposite to the nozzle faces of the printing unit 102 and the sensor face of the print detection unit 124, and suctioned by a fan 135, so that a negative pressure is generated in the suction chamber 134, and the recording sheet 116 on the endless belt 133 is held by suction.

The power of a motor (not shown) is transmitted to at least one of the rollers 131 and 132 so that the endless belt 133 is driven clockwise in FIG. 10, and the recording sheet 116 held on the endless belt 133 is moved from left to right in FIG. 10.

In the case of borderless printing, ink can be deposited on the endless belt 133. Therefore, in order to clean the endless belt 133, a belt cleaning unit 136 is arranged at a predetermined (appropriate) position outside the loop of the endless belt 133 and the printing region.

A heating fan 140 is arranged on the upstream side of the printing unit 102 above the conveying path of the recording sheet 116 (which is realized by the suction-type belt conveyer 122). The heating fan 140 blows heated air to the recording sheet 116 before printing so as to heat the recording sheet 116 and facilitate drying of deposited ink.

Each of the heads 3K, 3C, 3M, and 3Y in the printing unit 102 is a so-called full-line type head, which is a linear head having a length corresponding to the maximum width of the recording sheet 116, and being arranged across the width of the recording sheet 116 (i.e., in the main scanning direction perpendicular to the feeding direction of the recording sheet 116) as illustrated in FIG. 11. Specifically, each of the heads 3K, 3C, 3M, and 3Y is a linear head in which the aforementioned plurality of ink-discharge outlets (nozzles) are arrayed over a length exceeding the maximum length of a side of the largest recording sheet 116 on which the inkjet recording apparatus 100 can print an image. The heads 3K, 3C, 3M, and 3Y corresponding to the inks of the different colors are arrayed upstream in this order along the feeding direction as illustrated in FIG. 11. Thus, a color image can be printed on the recording sheet 116 by discharging the inks of the different colors while conveying the recording sheet 116.

The print detection unit 124 may be constituted by, for example, a line sensor which takes an image formed of spots of the inks discharged from the printing unit 102, and detects, from the image taken by the line sensor, incomplete discharge, which can be caused by clogging of a nozzle or the like.

A rear drying unit 142 for drying the printed surface of the recording sheet 116 is arranged in the stage following the print detection unit 124. For example, the rear drying unit 142 is realized by a heating fan or the like. Since it is preferable to avoid contact with the printed surface before the ink on the printed surface is completely dried, it is preferable that the rear drying unit 142 dry the ink on the printed surface by blowing heated air.

In order to control the glossiness of the image printed on the recording sheet 116, a heating-and-pressurizing unit 144 is arranged in the stage following the rear drying unit 142. The heating-and-pressing unit 144 comprises a pressure roller 145 having a surface having predetermined projections and depressions, and transfers the predetermined projections and depressions to the printed surface of the recording sheet 116 by pressing the printed surface with the pressure roller 145 while heating the printed surface.

Finally, the printed recording sheet 116 produced as above is outputted from the sheet output unit 126. It is preferable to separately output test prints and prints for practical use. Therefore, the sheet output unit 126 includes a first output unit 126A for the prints for practical use and a second output unit 126B for the test prints. Although not shown, the inkjet recording apparatus 100 further comprises a sorting unit which sorts the printed recording sheets 116 into the test prints and the prints for practical use, and sends the test prints to the first output unit 126B, and the prints for practical use to the second output unit 126A.

Further, in the case where both of a test image and an image for practical use are concurrently printed on a recording sheet 116, it is possible to arrange a cutter 148, and separate a first portion of the recording sheet 116 on which the test image is printed and a second portion of the recording sheet 116 on which the image for practical use is printed.

### 8. EVALUATION OF EXAMPLES

The present inventor has produced ferroelectric films as concrete examples 1 and 2 according to the present invention and comparison examples 1 and 2 as indicated below.

### 8.1 CONCRETE EXAMPLES 1

A plurality of ferroelectric films as the concrete examples 1 according to the present invention have been produced as follows.

First, substrates having an electrode have been produced by forming by sputtering Ban adhesion layer of titanium (Ti) having a thickness of 10 nm and a lower electrode of iridium (Ir) having a thickness of 150 nm in this order on a SOI (silicon-on-insulator) substrate with a diameter of 6 inches.

Next, four different types of Bi- and Nb-codoped PZT ferroelectric films (which are hereinafter referred to as Bi,Nb-PZT films) have been formed on the above substrates in the atmosphere of a mixture of Ar and 1.0 volume percent O₂ at the degree of vacuum of 0.5 Pa by using different targets having different compositions, respectively. The four different types of Bi,Nb-PZT films are PZT-based ferroelectric films respectively doped with different amounts of niobium (Bi) at the A sites. The film-formation temperature is 525° C., and the thicknesses of the ferroelectric films are 4 micrometers. During the film formation, each substrate has been held in a floating state at a distance of 60 mm from the target, and a ground (earth) has been arranged apart from the substrate outside the space between the substrate and the target. The plasma potential Vs and the floating potential Vf have been measured, and the difference Vs−Vf has been obtained as approximately 12 V. At this time, the floating potential Vf is the potential in the vicinity of the substrate, (specifically, the potential at the distance of approximately 10 mm from the substrate in this example). The RF input power is 500 W, and the molar ratio between Zr and Ti has been set to 52:48.

The present inventor has measured the compositions of the above four different types of Bi,Nb-PZT films by inductively coupled plasma (ICP) analysis, so that the Nb concentrations at the B sites in all the Bi,Nb-PZT films have been obtained as 12% (i.e., z=0.12), and the Bi concentrations at the A sites in the Bi,Nb-PZT films have been obtained as 2%, 4%, 8%, and 10% (i.e., x=0.02, 0.04, 0.08, and 0.10), respectively.

After the formation of the above Bi,Nb-PZT films, an upper electrode of platinum (Pt) having a thickness of 100 nm has been formed on each of the Bi,Nb-PZT films by sputtering, and patterned by liftoff. Thus, a plurality of piezoelectric devices respectively containing the Bi,Nb-PZT films have been produced.

In addition, the back surface of each SOI substrate has been processed by dry etching so as to produce an ink chamber 500 micrometers square, and each substrate has been processed or machined so as to produce a diaphragm having a thickness of 6 micrometers and an ink nozzle having the ink chamber and an ink-discharge outlet. Thus, production of inkjet recording heads constituted by the above piezoelectric devices respectively containing the above Bi,Nb-PZT films has been completed.

Further, the displacement of each of the Bi,Nb-PZT films has been measured by using the laser Doppler vibrometer, and the piezoelectric constant d31 has been calculated by using the structural analysis software “ANSYS”. In the calculation, the Young's modulus obtained on the basis of the resonance frequency is set to 50 MPa. The obtained values of the piezoelectric constant d31 are indicated in Table 1. In Table 1, d31(+) is the piezoelectric constant which has been measured when a positive voltage is applied to the upper electrode of each of the above piezoelectric devices (i.e., a positive electric field is applied to each ferroelectric film), and d31(−) is the piezoelectric constant which has been measured when a negative voltage is applied to the upper electrode of each of the piezoelectric devices (i.e., a negative electric field is applied to each ferroelectric film). The positive and negative voltages are ±20 V.

TABLE 1

| | Nb | | |
|---|---|---|---|
| | Concentration | d31(+) (pm/V) | d31(−) (pm/V) |
| Bi Concentration x | z | (+20 V) | (−20 V) |
| 0.02 | 0.12 | 150 | 200 |
| (Concrete Example 1) | | | |
| 0.04 | 0.12 | 190 | 190 |
| (Concrete Example 1) | | | |
| 0.08 | 0.12 | 150 | 150 |
| (Concrete Example 1) | | | |
| 0.10 | 0.12 | 110 | 110 |
| (Concrete Example 1) | | | |
| 0.0 | 0.12 | 90 | 250 |
| (Comparison Example | | | |
| 1) | | | |
| 0.12 | 0.12 | 90 | 90 |
| (Comparison Example | | | |
| 2) | | | |

As indicated in Table 1, each of the Bi,Nb-PZT films (doped with Bi) has the ratio d31(+)/d31(−) of approximately one and the piezoelectric constant d31(+) of 100 pm/V. That is, the Bi,Nb-PZT films doped with Bi in the piezoelectric devices produced as above have been confirmed as exhibiting satisfactory piezoelectric characteristics.

The present inventor has measured the bipolar P-E hysteresis characteristics of the above Bi, Nb-PZT films as the concrete examples 1 by applying to each piezoelectric device an electric field at the frequency of 5 Hz with the maximum electric field strength of 150 kV/cm, and has confirmed that the asymmetry is small in the P-E hysteresis curve of each of the above Bi,Nb-PZT films. For example, the P-E hysteresis characteristic of the Bi,Nb-PZT film in which the molar fraction x of Bi at the A sites is 0.04, which exhibits the highest d31(+) value among the Bi,Nb-PZT films as the concrete examples 1 as indicated in Table 1, is indicated in FIG. 12.

### 8.2 COMPARISON EXAMPLE 1

A Nb-doped PZT ferroelectric film (which is hereinafter referred to as a Nb-PZT film) as the comparison example 1 and a piezoelectric device and an inkjet recording head containing the Nb-PZT film have been produced in a similar manner to the concrete examples 1 except that the Nb-PZT film is not doped with Bi (i.e., x=0), and the piezoelectric constants d31(+) and d31(−) have been measured in a similar manner to the concrete examples 1. The measured piezoelectric constants d31(+) and d31(−) are also indicated in FIG. 12 and Table 1.

As indicated in Table 1, the bipolar P-E hysteresis characteristic curve of the Nb-PZT film as the comparison example 1 is greatly unbalanced toward the positive-electric-field side, i.e., asymmetric. In addition, Table 1 indicates that the Nb-PZT film as the comparison example 1 (which is not doped with Bi) has the very great d31(−) value of 250 pm/V and the small d31(+) value of 90 pm/V. However, as mentioned before, in order to satisfactorily and stably discharge ink from an inkjet recording head using a piezoelectric device, the ferroelectric film in the piezoelectric device is required to have the piezoelectric constant d31(+) above 100 pm/V. That is, the Nb-PZT film as the comparison example 1 (which is not doped with Bi) has been confirmed as not achieving sufficient displacement by application of a positive electric field.

### 8.3 COMPARISON EXAMPLE 2

A Bi,Nb-PZT film as the comparison example 2 and a piezoelectric device and an inkjet recording head containing the Bi,Nb-PZT film have been produced in a similar manner to the concrete examples 1 except that the Bi, Nb-PZT film is doped with Bi (x=0.12) so that the molar amounts of Bi and Nb are equalized (i.e., Bi:Nh=1:1). The piezoelectric constants d31(+) and d31(−) of the above Bi, Nb-PZT film have been measured in a similar manner to the concrete examples 1. The measured piezoelectric constants d31(+) and d31(−) are also indicated in Table 1.

As indicated in Table 1, the asymmetry in the bipolar P-E hysteresis characteristic curve of the Bi,Nb-PZT film as the comparison example 2 is small. That is, the asymmetry in the bipolar P-E hysteresis characteristic curve is reduced by doping with Bi. However, both of the piezoelectric constants d31(+) and d31(−) of the Bi,Nb-PZT film as the comparison example 2 are as small as 90 pm/V.

### 8.4 EVALUATION

As explained above, the doping with Bi reduces the asymmetry in the bipolar P-E hysteresis characteristic curve as indicated in FIG. 12, and approximately equalizes the piezoelectric constants d31(+) and d31(−) as indicated in Table 1. Further, the Bi,Nb-PZT film in which the molar fraction x of Bi at the A sites is 0.04 can achieve the d31(+) value as great as 190 pm/V.

FIG. 13 is a graph indicating values of the strain measured when various values of the voltage are applied to the Bi,Nb-PZT film as one of the concrete examples 1 (in which the molar fraction x of Bi at the A sites is 0.04) and the Nb-PZT film as the comparison example 1 after the films are respectively formed in the inkjet recording heads. The measurement has been performed by stepwise increasing the electric field applied to each film from 0 V to a positive extreme, stepwise decreasing the electric field from the positive extreme through 0 V to a negative extreme, and stepwise increasing the electric field from the negative extreme to 0 V.

As indicated in FIG. 13, the Nb-PZT film as the comparison example 1 exhibits a satisfactory (positive) voltage-strain characteristic when a negative electric field is applied to the film. However, in the range of the electric field between 0 V and approximately 20 V, the Nb-PZT film as the comparison example 1 exhibits a negative voltage-strain characteristic (i.e., exhibits negative strain even when a positive electric field is applied). That is, the Nb-PZT film as the comparison example 1 cannot exhibit sufficient displacement by application of a positive electric field in the range between the electric field between 0 V and approximately 30 V.

On the other hand, the Bi,Nb-PZT film as the one of the concrete examples 1 (in which the molar fraction x of Bi at the A sites is 0.04) also exhibits a negative voltage-strain characteristic when the electric field is increased from 0 V to approximately 12 V. However, the Bi,Nb-PZT film exhibits a positive voltage-strain characteristic (i.e., exhibits positive strain) in a part of the P-E hysteresis curve in which the electric field is increased above approximately 12 V to the positive extreme, and in another part of the P-E hysteresis curve in which the electric field is decreased from the positive extreme to 0 V. That is, the Bi,Nb-PZT film as the one of the concrete examples 1 (in which the molar fraction x of Bi at the A sites is 0.04) has been confirmed, on the basis of the result indicated in FIG. 13, as being able to exhibit sufficient displacement in the practical range of the driving voltage.

Further, it has been confirmed that the piezoelectric performance is lowered in the Bi,Nb-PZT film which is doped with the equal amounts of Bi and Nb. The present inventor considers that the coexistence of the crystals of BiNbO₄ lowers the piezoelectric performance. Therefore, when the Bi content is smaller than the Nb content in each Bi,Nb-PZT film according to the present invention, it is possible to consider that the piezoelectric performance of the Bi,Nb-PZT film is not lowered (i.e., the piezoelectric constant of 100 pm/V or greater can be achieved) even when the piezoelectric device constituted by the Bi,Nb-PZT film is driven by application of a positive electric field.

### 8.5 CONCRETE EXAMPLES 2

A La- and Nb-codoped PZT ferroelectric film (La, Nb-PZT film), a Nd- and Nb-codoped PZT ferroelectric film (Nd, Nb-PZT film), a Ba- and Nb-codoped PZT ferroelectric film (Ba,Nb-PZT film), and a Sr- and Nb-codoped PZT ferroelectric film (Sr,Nb-PZT film) in which the molar fraction of the A-site element La, Nd, Ba, or Sr is 4% (x=0.04) have been produced as the concrete examples 2 according to the present invention in a similar manner to the concrete examples 1 except that the above ferroelectric films as the concrete examples 2 are respectively doped with La, Nd, Ba, and Sr, instead of Bi. In addition, piezoelectric devices and inkjet recording heads containing the above ferroelectric films have been produced in a similar manner to the concrete examples 1.

Further, the piezoelectric constants of the the above four ferroelectric films as the concrete examples 2 formed in the inkjet recording heads have been measured in a similar manner to the concrete examples 1. The results of the measurement are indicated in Table 2. As indicated in Table 2, in each of the four ferroelectric films as the concrete examples 2, no difference has been observed between the piezoelectric performance during driving by application of a positive electric field and the piezoelectric performance during driving by application of a negative electric field. In addition, the piezoelectric constants of 100 pm/V or greater have been observed in the above four ferroelectric films as the concrete examples 2.

TABLE 2

| A-site Element | | d31(+) (pm/V) | d31(−) (pm/V) |
|---|---|---|---|
| (x = 0.04) | Nb Concentration z | (+20 V) | (−20 V) |
| La | 0.12 | 180 | 180 |
| Nd | 0.12 | 170 | 170 |
| Ba | 0.12 | 150 | 150 |
| Sr | 0.12 | 140 | 140 |

### 9. ADDITIONAL MATTERS

The ferroelectric film according to the present invention can be preferably used in piezoelectric actuators, ferroelectric memories, and the like, where the piezoelectric actuators may be mounted in the inkjet recording heads, magnetic recording-and-reproduction heads, MEMS (micro electromechanical systems) devices, micropumps, ultrasonic probes, and the like.

What is claimed is:

1. A perovskite oxide having a composition expressed by a compositional formula,
(Pb_{1-x+δ}Aₓ)(Zr_{y}Ti_{1-y})_{1-z}M_{z}O_{w},
where Pb and A are A-site elements, Zr, Ti, and M are B-site elements, A represents one or more A-site elements other than Pb, M represents one or more of elements Nb, Ta, V, Sb, Me, and W, x, y, and z satisfy inequalities,
0.01<x≦0.4,
0<y≦0.7, and
0.1≦z≦0.4, and
δ is approximately 0, w is approximately 3, δ and w may deviate from 0 and 3, respectively, within ranges of δ and w in which the composition expressed by the compositional formula (Pb_{1-x-δ}Aₓ)(Zr_{y}Ti_{1-y})_{1-z}M_{z}O_{w} can substantially realize a perovskite structure.

2. A perovskite oxide according to claim 1, wherein 0.01<x<z.

3. A perovskite oxide according to claim 1, wherein said one or more A-site elements represented by A have an ionic radius greater than 1.0 angstroms.

4. A perovskite oxide according to claim 3, wherein said one or more A-site elements represented by A are divalent or trivalent elements.

5. A perovskite oxide according to claim 4, wherein said one or more A-site elements represented by A are one or more of metal elements Ca, Sr, Ba, Eu, Bi, Y, La, Ce, Pr, Nd, Sm, Cd, Tb, Dy, Ho, Er, Tm, Yb, and Lu.

6. A perovskite oxide according to claim 5, wherein said one or more A-site elements represented by A are Bi.

7. A perovskite oxide according to claim 1, wherein said one or more B-site elements represented by M are Nb.

8. A perovskite oxide according to claim 1, wherein 0<δ≦0.2.

9. A perovskite oxide according to claim 1, containing substantially neither of silicon and germanium.

10. A ferroelectric film containing said perovskite oxide according to claim 1.

11. A ferroelectric film according to claim 10, having a thickness of 3.0 micrometers or greater.

12. A ferroelectric film according to claim 10, formed by a non-thermal equibrium process.

13. A ferroelectric film according to claim 12, formed by sputtering.

14. A ferroelectric film according to claim 10, having a film structure constituted by a plurality of columnar crystals.

15. A ferroelectric film according to claim 14, having a first piezoelectric constant d31(+) and a second piezoelectric constant d31(−) which satisfy an inequality,
d31(+)/d31(−)>0.5,
where the first piezoelectric constant d31(+) is measured by forming a lower electrode on a lower surface of the ferroelectric film and an upper electrode on an upper surface of the ferroelectric film, and applying a voltage to the ferroelectric film through the lower electrode and the upper electrode so that the upper electrode is at an electric potential higher than the lower electrode, the second piezoelectric constant d31(−) is measured by applying a voltage to the ferroelectric film through the lower electrode and the upper electrode so that the lower electrode is at an electric potential higher than the upper electrode, the lower surface is on a first side of the ferroelectric film from which the plurality of columnar crystals are grown, and the upper surface is on a second side of the ferroelectric film toward which the plurality of columnar crystals are grown.

16. A ferroelectric device comprising:
said ferroelectric film according to claim 10; and
electrodes through which an electric field is to be applied to the ferroelectric film.

17. A liquid discharge device comprising:
said ferroelectric device according to claim 16; and
a discharge member being formed integrally with or separately from said ferroelectric device, and including,
a liquid-reserve chamber which reserves liquid, and
a liquid-discharge outlet through which said liquid is externally discharged from the liquid-reserve chamber.
